(19) United States
(12) Patent Application Publication
(10) Pub. No.: US 2009/0158960 A1
(43) Pub. Date: Jun. 25, 2009

(54) HIGHLY WORKABLE CONCRETE COMPOSITIONS HAVING MINIMAL BLEEDING AND SEGREGATION

(75) Inventors: Per Just Andersen, Santa Barbara, CA (US); Simon K. Hodson, Santa Barbara, CA (US)

Correspondence Address: Patent Docket Department;Armstrong Teasdale LLP, One Metropolitan Square, Suite 2600, St. Louis, MO, 63102-2740, US

(73) Assignee: iCRETE, LLC, Beverly Hills, CA (US)

(21) Appl. No.: 12/247,308

(22) Filed: Oct. 8, 2008

Related U.S. Application Data
(60) Provisional application No. 61/015,599, filed on Dec. 20, 2007.

(51) Int. Cl. C04B 7/00; C04B 24/24

(52) U.S. Cl. 106/15.05; 106/638; 106/817; 524/2

(57) ABSTRACT

Concrete compositions have a fine-to-coarse aggregate ratio optimized for increased workability with minimal segregation and bleeding. The concrete compositions include at least water, cement, coarse aggregate, and fine aggregate and have a slump of at least 1 inch and a 28-day compressive strength of at least about 1500 psi. Workability is improved by minimizing the viscosity as a function of the aggregate content, while minimizing segregation and bleeding. To improve workability, the concrete compositions include between 45% and 65% fine aggregate and between 35% and 55% coarse aggregate as a function of total aggregate volume. For relatively low strength concrete (1500-4500 psi), the fine aggregate is 55-65% of the total aggregate volume. For medium strength concrete (4500-8000 psi), the fine aggregate is 50-60% of the total aggregate volume. For high strength concrete (>8000 psi), the fine aggregate is 45-55% of the total aggregate volume. Overall workability can be maintained or improved even if slump is decreased.

### CROSS REFERENCE TO RELATED APPLICATION

This application is a non-provisional patent application claiming priority from U.S. Provisional Application 61/015,599 filed Dec. 20, 2007. The entire text of which is hereby incorporated by reference in its entirety.

### BACKGROUND OF THE DISCLOSURE

1. The Field of the Disclosure

The disclosure is in the field of concrete compositions, particularly concrete compositions having a positive slump, high workability and cohesiveness, and minimal bleeding and segregation. This is accomplished by optimizing the ratio of fine to coarse aggregates.

2. The Relevant Technology

Workability of fresh concrete is conventionally quantified in terms of “slump.” Slump is a crude measurement of concrete rheology and is determined using a standard slump cone of predefined volume and angle. FIG. 1A illustrates an example slump cone 100. The slump cone includes a top opening 102 and a bottom opening 104. As shown in FIG. 1B, the slump cone 100 is used by placing the slump cone 100 on a flat surface and then filling the cone with fresh concrete through top opening 102. Slump cone 100 is filled to the very top 102 and any excess concrete is scraped off. The slump cone 100 is then removed from the fresh concrete 110 by lifting cone 100 up. Without slump cone 100 to hold concrete 110 up, concrete 110 falls from a height 116 to a height 112. The distance 114 that the concrete 110 falls is referred to as “slump”. The slump is used to predict how well the concrete material will flow or move under the force of gravity or positive force into a desired position.

Although widely used for decades throughout the concrete industry as the standard measurement of workability, slump is only a rough approximate of actual workability because it only measures the effect of gravity on concrete rheology. It does not account for labor increasing effects caused by segregation, bleeding, high viscosity, and delays in surface finishability. Moreover, workers in the field (e.g., concrete truck drivers, placers and finishers) typically do not measure slump with a slump cone, but instead generally evaluate the concrete based on look and feel. Slump adjustments are often made by adding water to the concrete at the job site, with the belief that more fluid concrete having higher slump will be easier to finish. In fact, overwatering concrete reduces strength (i.e., by increasing the water-to-cement ratio), reduces cohesion, increases segregation and bleeding, and increases the wait time before the surface can be finished in the case of flat work (e.g., driveways, sidewalks, porches, and the like).

According to ACI 302.1R-04, paragraph 8.3.5, Guide for Concrete Floor and Slab Construction: concrete can be finished after it has reached a degree of firmness that permits a person to stand on the surface while sinking only ¼ inch. Increasing concrete slump, particularly by increasing water content, may therefore in crease finishing costs by substantially increasing fluidity and delaying when the concrete reaches sufficient firmness to permit surface finishing. The time and cost of finishing concrete may also be increased by efforts required to prevent and/or remediate segregation and bleeding caused by overwatering.

In view of the foregoing, it is not surprising that relatively high strength concrete used to manufacture large building structures, roadways, etc., as opposed to grouts, mortars and zero slump concrete used to manufacture pipes or which is sprayed onto a vertical surface, typically include about 60-70% by volume coarse aggregate as a percentage of the overall aggregate content.

By way of example, ACI standard 211 represents a recommended concrete design procedure. An exemplary concrete composition made according to the “PCC Mix Proportioning Example (Using the ACI Method)” is described on the web at http://training.ce.washington.edu/WSDOTIModules/05 mix design/pcc example.htm. This example demonstrates the recommended proportions of components used to manufacture 27 cubic feet (i.e., 1 cubic yard) (alternatively 1 cubic meter) of concrete having a slump of 1 inch (or 2.5 cm) and a 28-day compressive strength of about 6500 psi (44.8 MPa), which are as follows:

| | Metric | English |
|---|---|---|
| Unit volume (1 m³ or ft³) | 1.000 m³ | 27.00 ft³ |
| Mixing Water | 0.148 m³ | 4.00 ft³ |
| Air | 0.055 m³ | 1.49 ft³ |
| Portland Cement | 0.121 m³ | 3.26 ft³ |
| Coarse Aggregate | 0.424 m³ | 11.46 ft³ |
| Fine Aggregate | 0.252 m³ | 6.79 ft³ |

The foregoing example demonstrates that a typical concrete composition manufactured using standard design techniques includes a coarse aggregate content of 11.46 cubic feet (0.424 cubic meter) and a fine aggregate content of 6.79 cubic feet (0.252 cubic meter). That corresponds to a coarse aggregate concentration of about 62.8% by volume of total aggregate and a fine aggregate concentration of about 37.2% by volume of total aggregate. The volumetric ratio of coarse to fine aggregate is therefore 1.688 using the standard ACI method. That is consistent with efforts to increase slump while minimizing overall water content by maximizing particle packing density.

Notwithstanding the foregoing, which represents the current standard and recommended conventional practice for manufacturing concrete, slump is only a crude measurement of actual workability, and increasing slump does not necessarily improve workability. Overall workability includes the amount of labor and energy required to place, consolidate and finish the surface of fresh concrete. Selecting a ratio of coarse-to-fine aggregate that maximizes particle packing density and slump does not necessarily improve workability. Indeed, part of workability is finishability (i.e., the ability to trowel, smooth and finally finish the surface of fresh concrete), which typically requires a reduction in slump. Maximizing slump may increase the time before the surface of fresh concrete can be finished. It may also increase bleeding and segregation, which can reduce both workability and strength.

To achieve high slump while minimizing segregation and bleeding, it is customary in the art to include high quantities of relatively expensive cement, fine particulate fillers, water reducers, superplasticizers, rheology-modifying agents, and the like.

In view of the foregoing, there remains a need to develop a better metric for measuring and defining workability, as well as improved and better optimized concrete compositions which have improved workability in order to reduce the energy and/or labor required to finish concrete at a job site, while also minimizing or eliminating segregation and bleeding.

### BRIEF SUMMARY OF THE DISCLOSURE

It has now been found that viscosity, not slump, is a more accurate measurement or predictor of concrete “workability” (i.e., the amount of mechanical energy and/or physical man power required to position and finish a fresh concrete composition). It has surprisingly been found that, contrary to commonly accepted practices and beliefs, concrete workability can be optimized by minimizing viscosity, in some cases even while reducing slump, while minimizing or eliminating bleeding and segregation. This is accomplished by selecting a fine-to-coarse aggregate ratio within specific narrow ranges disclosed herein.

Improving workability independently of slump, and in some cases by actually reducing slump, is contrary to standard practices, in which slump is believed to correlate with and therefore directly measure concrete workability. It is generally assumed by concrete manufacturers and workers in the field that increasing slump increases workability. However, this practice neglects key components of workability which are attributable to viscosity, segregation and bleeding. While slump might accurately measure how a particular concrete composition flows when acted upon by gravity, it is a poor indicator of how much work or placement energy is required to actually configure and finish a fresh concrete composition. It also does not measure the extent of segregation and bleeding, which can deleteriously affect both workability and strength.

The present disclosure improves the workability of fresh concrete by minimizing macro viscosity, segregation and bleeding by increasing the fine-to-coarse aggregate ratio to a range in which viscosity, segregation and bleeding are minimized. In general, the workability of fresh concrete compositions having a slump of about 1-12 inches (or about 2.5-30 cm) and which have a 28-day compressive strength of at least about 1500 psi (or at least about 10 MPa) can be minimized, while minimizing or eliminating segregation and bleeding, by including a fine aggregate volume of about 45-65% of the overall aggregate volume and a coarse aggregate volume of about 35-55% of the overall aggregate volume for typical concrete compositions. The foregoing range broadly encompasses low strength concretes, in which the fine aggregate can be as high as about 65% by volume of the aggregate fraction, and very high strength concretes (i.e., greater than about 10,000 psi, or about 70 MPa), in which the fine aggregate can be as low as about 45% by volume of the aggregate fraction. The “aggregate volume” is the actual (or “material”) volume of solid aggregates exclusive of void space between the particles.

Preferably, the volume of fine aggregate is in a range of about 47% to about 63% of the overall aggregate volume, and the volume of coarse aggregate is in a range of about 37% to about 53% of the overall aggregate volume. More preferably, the volume of fine aggregate is in a range of about 48.5% to about 61.5% of the overall aggregate volume, and the volume of coarse aggregate is in a range of about 38.5% to about 51.5% of the overall aggregate volume. Most preferably, the volume of fine aggregate is between 50-60% of the overall aggregate volume, and the volume of coarse aggregate is between 40-50% of the overall aggregate volume.

The foregoing ranges generally apply to concrete having a 28-day compressive strength greater than 1500 psi (or greater than 10 MPa). However, the amount of fine aggregate required to maximize workability, while minimizing or eliminating segregation and bleeding, generally decreases with increasing concrete strength. Accordingly, for concrete having relatively low 28-day compressive strength (i.e., 1500-4500 psi, or 10.3-31 MPa), workability is maximized, with minimal or no segregation and bleeding, by including a volume of fine aggregate of about 55-65%, and a volume of coarse aggregate of about 35-45%, of the overall aggregate volume. Preferably, the volume of fine aggregate is in a range of about 56.0% to about 64.5%, and the volume of coarse aggregate is in a range of about 35.5% to about 44.0%, of the overall aggregate volume. More preferably, the volume of fine aggregate is in a range of about 57.0% to about 64.0%, and the volume of coarse aggregate is in a range of about 36.0% to about 43.0%, of the overall aggregate volume. Most preferably, the volume of fine aggregate is in a range of about 58.0% to about 63.5%, and the volume of coarse aggregate is in a range of about 36.5% to about 42.0%, of the overall aggregate volume.

For concrete having moderate 28-day compressive strength (i.e., 4500-8000 psi, or 31-55 MPa), workability is maximized, with minimal or no segregation and bleeding, by including a volume of fine aggregate between 50-60%, and a volume of coarse aggregate between 40-50%, of the overall aggregate volume. Preferably, the volume of fine aggregate is in a range of about 50.5% to about 59.5%, and the volume of coarse aggregate is in a range of about 40.5% to about 49.5%, of the overall aggregate volume. More preferably, the volume of fine aggregate is in a range of about 51.0% to about 59.0%, and the volume of coarse aggregate is in a range of about 41.0% to about 49.0%, of the overall aggregate volume. Most preferably, the volume of fine aggregate is in a range of about 51.5% to about 58.5%, and the volume of coarse aggregate is in a range of about 41.5% to about 48.5%, of the overall aggregate volume.

For concrete having high 28-day compressive strength (i.e., at least 8000 psi, or 55 MPa), workability is maximized, with minimal or no segregation and bleeding, by including a volume of fine aggregate of about 45-55%, and a volume of coarse aggregate of about 45-55%, of the overall aggregate volume. Preferably, the volume of fine aggregate is in a range of about 45.5% to about 54.0%, and the volume of coarse aggregate is in a range of about 46.0% to about 54.5%, of the overall aggregate volume. More preferably, the volume of fine aggregate is in a range of about 46.0% to about 53.0%, and the volume of coarse aggregate is in a range of about 47.0% to about 54.0%, of the overall aggregate volume. Most preferably, the volume of fine aggregate is in a range of about 46.5% to about 52.0%, and the volume of coarse aggregate is in a range of about 48.0% to about 53.5%, of the overall aggregate volume.

The viscosity of fresh concrete as a function of the fine-to-coarse aggregate ratio generally increases precipitously outside (i.e., above and below) the broader ranges set forth above. Without being bound to any particular theory, it is postulated that below the minima, or lower range endpoints, for fine aggregate concentration, friction between and among the coarse aggregate particles rapidly increases as spatial separation between the coarse aggregate particles decreases beyond a critical point. Within the claimed ranges, friction between coarse aggregate particles is suddenly and substantially reduced by the presence of fine aggregate particles interposed between and separating the coarse aggregate particles. Above the maxima, or upper range endpoints, for fine aggregate concentration, the friction-reducing effect of the fine aggregate particles is overtaken by the viscosity-increasing effect of water absorption by the fine aggregate particles. Within the claimed ranges, the water-absorbing and viscosity-increasing effect of the fine aggregate particles is dwarfed and overwhelmed by the tremendous viscosity-reducing effect of spatially separating the coarse aggregate particles. Thus, the inclusion of fine and coarse aggregates within the claimed ranges hits the “sweet spot” of high workability in a predictable and reproducible manner.

Within the foregoing ranges, the fresh concrete compositions also have a high level of cohesiveness, which further enhances overall workability by inhibiting or minimizing or eliminating segregation and bleeding. “Segregation” is the separation of the components of the concrete composition, particularly separation of the cement paste fraction from the aggregate fraction and/or the mortar fraction from the coarse aggregate fraction. “Bleeding” is the separation of water from the cement paste. Segregation can reduce the strength of the poured concrete and/or result in uneven strength and other properties. Reducing segregation may result in fewer void spaces and stone pockets, improved filling properties (e.g., filling around rebar or metal supports), and improved pumping of the concrete.

While increasing the amount of fine aggregate generally improves cohesiveness, it also tends to decrease viscosity of concrete within the foregoing ranges, and there is good overall cohesiveness coupled with low viscosity on a consistent and predictable basis. Increasing the cohesiveness of concrete contributes to improved workability because it minimizes the care and effort that must otherwise be taken to prevent segregation and/or bleeding during placement and finishing. Increased cohesiveness also provides a margin of safety that permits greater use of plasticizers without causing segregation and blocking.

Because the aggregates make up the bulk of the concrete, improvements in workability, segregation and bleeding as a function of the fine-to-coarse aggregate ratio can have a significant effect on the overall workability of the concrete mixture. In contrast, the volume fraction of cement paste in the concrete is typically much less than the volume fraction of the aggregate. Consequently, improving the workability and reducing segregation and bleeding of the overall fresh concrete via the cement paste requires significantly altering the cement paste (e.g., using significant amounts of water, which reduces strength, or rheology modifying admixtures, which greatly increase cost) and/or increasing the amount of cement paste, which increases the cost of concrete and may result in overcementing. It is possible, and often desirable, to simultaneously decrease macro viscosity while increasing micro (or mortar) viscosity in a manner that maximizes overall workability while minimizing segregation and bleeding.

In summary, important variables as they relates to workability are viscosity, segregation and bleeding of the fresh concrete composition, as reducing viscosity, segregation and bleeding reduces the work and energy that is required to position the fresh concrete composition in a desired configuration. It turns out that a relatively unimportant variable of workability is slump, which does not directly correlate with and measure viscosity, segregation or bleeding and which is inversely proportional to yield stress. Slump is a poor measure of concrete workability, as measured by the overall time, energy and manpower required to position and finish concrete. To the extent that increasing slump also causes segregation and/or bleeding, slump is a further negative contributor to overall workability, as additional care must be taken to prevent and/or remedy segregation and/or bleeding.

Although optimizing concrete for cost (e.g., by lowering the cement content) is always an attractive option for a concrete manufacturer, a concrete finisher may care more about finishing costs than raw materials cost, particularly where finishing costs exceed those of raw materials costs. In some cases, the cost of finishing concrete can be as much as about 2-5 times the cost of the concrete material itself. Improving the workability and cohesiveness of fresh concrete can yield cost savings which substantially exceed savings resulting from lowering materials costs alone through optimization. In fact, it is possible to decrease the overall cost of a job while increasing the cost of concrete so long as the cost of finishing the concrete is reduced by an amount that exceeds any increase in materials cost. Thus, maximizing workability according to the present disclosure may not necessarily result in less expensive concrete, and may even increase the materials cost in some cases. Nevertheless, any such cost increases are typically substantially less than cost increases that would otherwise result by simply adding more cement and/or using expensive admixtures to improve workability and decrease segregation and bleeding as is common in the industry.

These and other advantages and features of the present disclosure will become more fully apparent from the following description and appended claims, or may be leaned by the practice of the disclosure as set forth hereinafter.

### BRIEF DESCRIPTION OF THE DRAWINGS

To further clarify the above and other advantages and features of the present disclosure, a more particular description of the disclosure will be rendered by reference to specific embodiments thereof which are illustrated in the appended drawings. It is appreciated that these drawings depict only typical embodiments of the disclosure and are therefore not to be considered limiting of its scope. The disclosure will be described and explained with additional specificity and detail through the use of the accompanying drawings, in which:

FIG. 1A is a perspective view of a standard slump cone;

FIG. 1B is an elevational view of the standard slump cone of FIG. 1A and a pile of fresh concrete schematically illustrating the use of the slump cone;

FIG. 2 is a graph that schematically illustrates and compares the rheology of fresh concrete compared to a Newtonian fluid;

FIG. 3 is an exemplary ternary diagram for a three particle system consisting of cement, sand and rock illustrating a shift to the left representing an increase in the ratio of sand to rock;

FIGS. 4A and 4B are graphs that schematically illustrate the effect on the macro rheology of fresh concrete as a result of first increasing the sand content and then adding a plasticizer to a concrete composition;

FIGS. 5A and 5B are graphs that schematically illustrate the effect on the micro rheology of fresh concrete as a result of first increasing the sand content and then adding a plasticizer to a concrete composition;

FIG. 6 is a graph that schematically illustrates the viscosity of a fresh concrete composition as a function of the volume fraction of fine aggregate;

FIG. 7A is a graph that schematically illustrates the viscosity of a fresh concrete composition as a function of the volume fraction of fine aggregate for a concrete composition with relatively low strength;

FIG. 7B is a graph that schematically illustrates the viscosity of a fresh concrete composition as a function of the volume fraction of fine aggregate for a concrete composition with medium strength;

FIG. 7C is a graph that schematically illustrates the viscosity of a fresh concrete composition as a function of the volume fraction of fine aggregate for a concrete composition with relatively high strength;

FIG. 8 is a graph that schematically illustrates the yield stress of a concrete composition as a function of the volume fraction of fine aggregate;

FIG. 9 is a graph that schematically illustrates the yield stress of a concrete composition as a function of slump;

FIG. 10 is a flow diagram showing a method for designing concrete having high workability according to one embodiment of the disclosure; and

FIG. 11 is a flow diagram showing a method for selecting a ratio of fine-to coarse aggregates according to one embodiment of the disclosure.

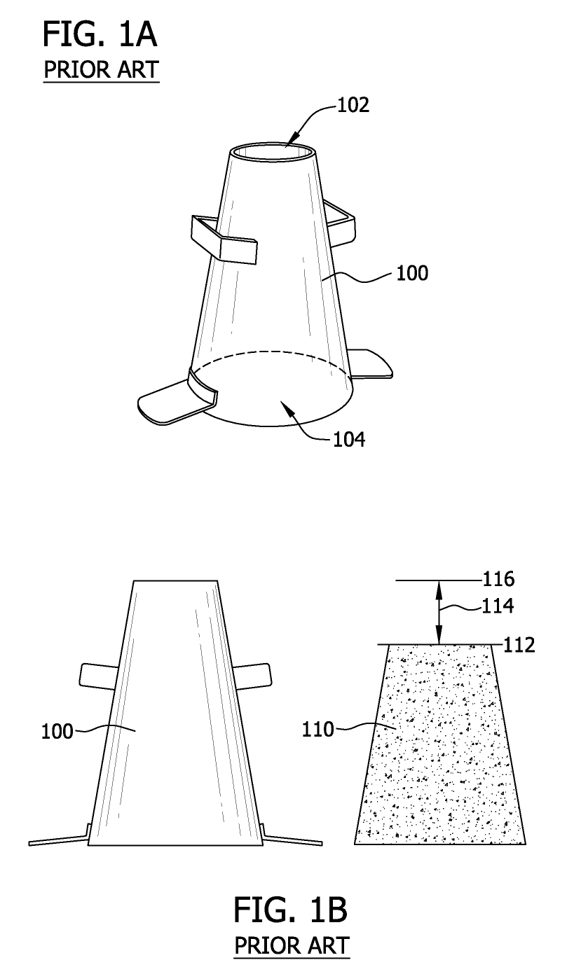

### DETAILED DESCRIPTION OF THE PREFERRED EMBODIMENTS

### I. Introduction

The present disclosure is directed to concrete compositions having a fine-to-coarse aggregate ratio that is optimized to give the fresh concrete composition improved workability, while minimizing or eliminating segregation and bleeding. The concrete compositions include about 45-65% fine aggregates and about 35-55% coarse aggregates as a fraction of the overall aggregate volume. Selecting an amount of fine and coarse aggregate within the foregoing ranges minimizes the viscosity of the fresh concrete thereby substantially improving “workability” as it pertains to positioning and finishing the concrete, while also minimizing or eliminating segregation and bleeding.

Surprisingly, minimizing viscosity, segregation and bleeding by carefully controlling the fine to coarse aggregate ratio, even if slump is reduced, provides a net gain in workability, all things being equal (e.g., strength, paste content, admixtures, etc.). Contrary to commonly accepted practices and beliefs, concrete workability can be greatly improved by minimizing viscosity, even while increasing the yield stress (i.e., decreasing slump). Minimizing viscosity, segregation and bleeding greatly decreases the amount of energy and work that must be imparted to a fresh concrete composition to move it into a desired configuration, thereby reducing labor and equipment costs associated with positioning and finishing concrete.

The foregoing relationship between the fine-to-coarse aggregate ratio, lowered viscosity, segregation and bleeding, and improved workability applies mainly to concrete compositions which include have a slump of at least 1 inch (typically between 2-12 inches, or 2.5-30 cm) and a 28-day strength of at least about 1500 psi (or about 10 MPa).

As used herein, the term “concrete” refers to a composition that includes a cement paste fraction and an aggregate fraction and is an approximate Bingham fluid.

The terms “cement paste” and “paste fraction” refer to the fraction of concrete that includes, or is formed from a mixture that comprises, one or more types of hydraulic cement, water, and optionally one or more types of admixtures. Freshly mixed cement paste is an approximate Bingham fluid and typically includes cement, water and optional admixtures. Hardened cement paste is a solid which includes hydration reaction products of cement and water.

The terms “aggregate” and “aggregate fraction” refer to the fraction of concrete which is generally non-hydraulically reactive. The aggregate fraction is typically comprised of two or more differently-sized particles, often classified as fine aggregates and coarse aggregates.

The term “mortar fraction” refers to the paste fraction plus the fine aggregate fraction but excludes of the coarse aggregate fraction.

As used herein, the terms “fine aggregate” and “fine aggregates” refer to solid particulate materials that pass through a Number 4 sieve (ASTM C125 and ASTM C33).

As used herein, the terms “coarse aggregate” and “coarse aggregates” refer to solid particulate materials that are retained on a Number 4 sieve (ASTM C125 and ASTM C33).

As used herein, “fresh concrete” refers to concrete that has been freshly mixed together and which has not reached initial set.

As used herein, the term “macro rheology” refers to the rheology of fresh concrete.

As used herein, the term “micro rheology” refers to the rheology of the mortar fraction of fresh concrete, exclusive of the coarse aggregate fraction.

As used herein, the term “segregation” refers to separation of the components of the concrete composition, particularly separation of the cement paste fraction from the aggregate fraction and/or the mortar fraction from the coarse aggregate fraction.

As used herein, the term “bleeding” refers to separation of water from the cement paste.

II. Components used to make Concrete Compositions

The concrete compositions of the disclosure include at least one type of hydraulic cement, water, at least one type of fine aggregate, and at least one type of coarse aggregate. In addition to these components, the concrete compositions can include other admixtures to give the concrete desired properties.

A. Hydraulic Cement, Water, and Aggregate

Hydraulic cements are materials that can set and harden in the presence of water. The cement can be a Portland cement, modified Portland cement, or masonry cement. For purposes of this disclosure, Portland cement includes all cementitious compositions which have a high content of tricalcium silicate, including Portland cement, cements that are chemically similar or analogous to Portland cement, and cements that fall within ASTM specification C-150-00. Portland cement, as used in the trade, means a hydraulic cement produced by pulverizing clinker, comprising hydraulic calcium silicates, calcium aluminates, and calcium aluminoferrites, and usually containing one or more of the forms of calcium sulfate as an interground addition. Portland cements are classified in ASTM C 150 as Type I, II, HI, Psi, and V. Other cementitious materials include ground granulated blast-furnace slag, hydraulic hydrated lime, white cement, slag cement, calcium aluminate cement, silicate cement, phosphate cement, high-alumina cement, magnesium oxychloride cement, oil well cements (e.g., Type VI, VII and VIII), and combinations of these and other similar materials.

Pozzolanic materials such as slag, class F fly ash, class C fly ash and silica fume can also be considered to be hydraulically settable materials when used in combination with convention hydraulic cements, such as Portland cement.

The amount of hydraulic cement and pozzolanic material in the fresh cementitious composition can vary depending on the identities and concentrations of the other components. In general, the combined amount of hydraulic cement and pozzolanic material is preferably in a range of about 5% to about 30% by volume of the fresh cementitious mixture, more preferably in a range of about 7% to about 25% by volume of the fresh cementitious mixture, and most preferably in a range of about 10% to about 22% by volume of the fresh cementitious mixture.

According to one embodiment, the total combined amount of hydraulic cement and fine particulate fillers (e.g., limestone) having a particle size less than 150 microns is preferably less than about 15% by volume of the fresh cementitious mixture for concrete compositions having a design strength up to about 7000 psi (about 50 MPa), less than about 20% by volume of the fresh cementitious mixture for concrete compositions having a design strength of about 7000-14,000 psi (about 50-100 MPa), and less than about 22% by volume of the fresh cementitious mixture for concrete compositions having a design strength greater than about 14,000 psi (about 100 MPa).

Water is added to the concrete mixture in sufficient amounts to hydrate the cement and provide desired flow properties and rheology. Those skilled in the art will recognize that the amount of water needed will depend on the desired flowability and on the amounts and types of admixtures included in the concrete composition. In general, the amount of water is preferably in a range of about 13% to about 21% by volume of the fresh cementitious mixture, more preferably in a range of about 14% to about 20% by volume of the fresh cementitious mixture, and most preferably in a range of about 15% to about 19% by volume of the fresh cementitious mixture.

Aggregates are included in the cementitious material to add bulk and to give the concrete strength. The aggregate includes both fine aggregate and coarse aggregate. Examples of suitable materials for coarse and/or fine aggregates include silica, quartz, crushed round marble, glass spheres, granite, limestone, bauxite, calcite, feldspar, alluvial sands, or any other durable aggregate, and mixtures thereof. In a preferred embodiment, the fine aggregate consists essentially of “sand” and the coarse aggregate consists essentially of “rock” as those terms are understood by those of skill in the art. Appropriate aggregate concentration ranges are provided elsewhere.

B. Additional Admixtures

A wide variety of admixtures can be added to the cementitious compositions to give the fresh cementitious mixtures and/or cured concrete desired properties. Examples of admixtures that can be used in the cementitious compositions of the disclosure include, but are not limited to, air entraining agents, strength enhancing amines and other strengtheners, dispersants, water reducers, superplasticizers, water binding agents, rheology-modifying agents, viscosity modifiers, set accelerators, set retarders, corrosion inhibitors, pigments, wetting agents, water soluble polymers, water repellents, strengthening fibers, permeability reducers, pumping aids, fungicidal admixtures, germicidal admixtures, insecticidal admixtures, finely divided mineral admixtures, alkali reactivity reducer, and bonding admixtures.

III. Concrete Compositions having High Workability with Minimal Segregation and Bleeding

The cementitious compositions of the disclosure are mixtures of cement, water, aggregates, and optionally other admixtures that are selected and combined to optimize workability while minimizing or eliminating segregation and bleeding. Workability is optimized by selecting a fine-to-coarse aggregate ratio that minimizes viscosity. The ability to improve the workability of a cementitious material by selecting a desired ratio of fine to coarse aggregates is derived from the nature of fresh concrete, which in some respects approximates the behavior of a Bingham fluid. Information relating to concrete rheology in general, and Binghamian behavior in particular, is found in Andersen, P., “Control and Monitoring of Concrete Production: A Study of Particle Packing and Rheology,” Danish Academy of Technical Sciences, Doctoral Thesis (1990) (“Andersen Thesis”), which is incorporated by reference.

A. Concrete Rheology

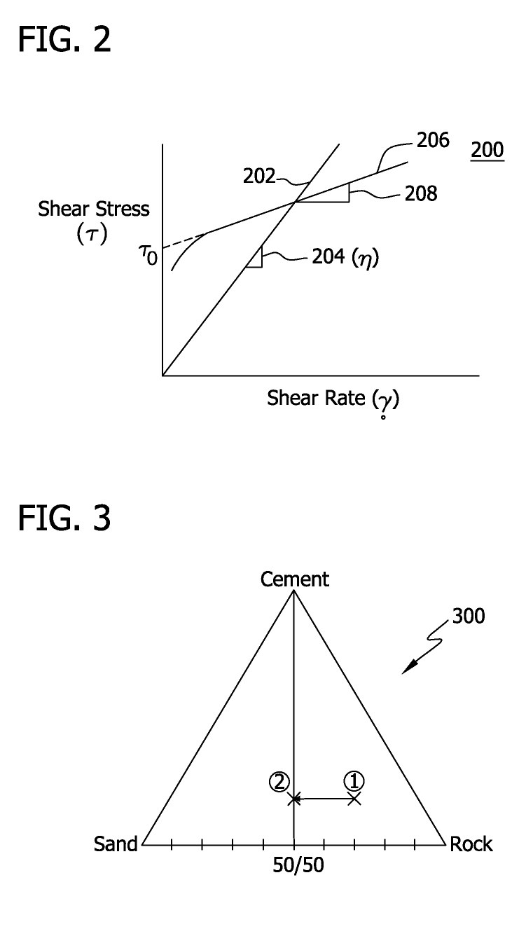

FIG. 2 shows a schematic diagram 200 illustrating the rheology of concrete, which is an approximate Bingham fluid, as it compares to a Newtonian fluid such as water. Water is a classic Newtonian fluid in which the relationship between shear stress (τ) and shear rate (γ) is represented by a linear curve 202 (i.e., a straight line of constant slope 204) that passes through the origin. The slope 204 of the curve 202 represents the viscosity (η), and the y-intercept of the curve 202 represents the yield stress (τₒ), or shear stress (τ) when the shear rate (γ) is 0. The yield stress (τₒ) of a Newtonian fluid is 0 when the shear rate (γ) is 0. That means a Newtonian fluid is able to flow under the force of gravity without applying additional force. Nevertheless, the linear curve 202 can be adjusted so as to have different slopes corresponding to Newtonian fluids having higher or lower viscosities.

In contrast, the Theological behavior of concrete can be approximated according to the following equation:

τ=τₒ_{₊}ηₚₗ γ (1)
where τ is the amount of force or placement energy required to move fresh concrete into a desired configuration,
τₒ is the yield stress (i.e., the amount of energy required to initially cause fresh concrete to initially move from a stationary position),
ηₚₗ is the plastic viscosity of fresh concrete (i.e., the change in shear stress divided by the change in shear rate), and
γ is the shear rate (i.e., the rate at which the concrete material is moved during placement).

The foregoing relationship can be plotted graphically for any fresh concrete composition having a positive slump and an approximate Bingham fluid behavior. Bingham fluid curve 206 shown in FIG. 2 has a changing slope at lower shear rates, a generally constant slope 208 at higher shear rates, and a positive y-intercept to, which is representative of the yield stress and which can be extrapolated by extending the straight portion of curve 206 using slope 208 to the y-axis. At low shear rates, the slope of curve 206 decreases with increasing shear rate, which means the apparent (or plastic) viscosity (ηₚₗ) of a Bingham fluid such as concrete initially decreases with increasing shear (γ). That is because approximate Bingham fluids such as concrete typically experience shear thinning. A Bingham has a positive yield stress (τₒ), whose value can be extrapolated from the slope 208 of the straight line portion of the Bingham fluid curve 206. In the case of concrete, the yield stress (τₒ) is approximately inversely proportional to slump, as illustrated in FIG. 9.

B. Relationship Between Concrete Rheology and Workability

The placement energy required to configure and finish fresh concrete can be represented by τ. Both the yield stress (τₒ) and plastic viscosity (ηₚₗ) are components of τ, as indicated by equation (1) above. One measure of “workability” of fresh concrete is the inverse of placement energy, as indicated by the following equation:

$$Workability = \frac{1}{τ} = \frac{1}{{τ}_{o} + {η}_{pl}^{′} γ} \qquad ( 2 )$$

That is, the workability of fresh concrete increases as the amount of placement energy required to configure concrete decreases. Conversely, the workability decreases as the as the amount of placement energy required to configure concrete increases.

As discussed above, it is conventional to believe that simply increasing the slump (i.e., decreasing the yield stress) increases workability. Slump is commonly used as the measure of concrete workability, as increasing the slump is understood to require less energy to position and finish the concrete. The problem with this assumption is that concrete is not a fluid, but a multi-phase mixture of liquid, solid and air that cannot be made to behave as a true fluid without eliminating the aggregate fraction. Aggregates do not themselves “flow” but rather move together with the paste fraction of fresh concrete. Increasing the fluidity of the cement paste does not increase the fluidity of the aggregate fraction. If the cement paste is made excessively fluid, the cement paste fraction will separate and move independently of the aggregate fraction, which causes “segregation”. Moreover, cement paste is also not a fluid because it contains solid cement grains suspended in a liquid phase consisting of water and liquid and/or dissolved admixtures. Adding too much fluid to the cement paste will cause the liquid phase to separate and move independently of the cement grains, which causes “bleeding”.

To prevent segregation, concrete must possess sufficient cohesion to maintain the required distribution of solid aggregates, cement paste, and air within the concrete mixture. Similarly, to prevent bleeding, the cement paste fraction must possess sufficient paste cohesion to maintain a homogeneous distribution of cement grains and liquid fraction. However, increasing the cohesion of both concrete and paste significantly affect both the yield stress and viscosity of the mixture, both of which have been found to affects workability. There is therefore a natural limit to the amount of fluidity that can be imparted to fresh concrete, using conventional concrete design and manufacturing methods, beyond which segregation and bleeding result in the absence of adding substantial quantities of expensive rheology-modifying admixtures.

By way of example, concrete that behaves most like a fluid is self-leveling concrete, which, when manufactured using conventional methods, requires the use of substantial quantities of expensive admixtures such as plasticizers and/or water-reducers to increase the fluidity of the paste fraction, as simply increasing the water concentration would greatly reduce strength. To prevent segregation and bleeding that would otherwise result from greatly increasing the fluidity of the cement paste, an increased amount of cement, a rheology-modifying agent and/or a fine particulate filler (e.g., limestone having a particle size less than 150 microns) must typically be added. Moreover, because water-reducers tend to retard selling, set accelerators are typically added to correct for such retardation. More cement may be required to further increase paste cohesion, prevent segregation and bleeding, and maintain strength (e.g., in the case where a substantial quantity of a set accelerator is required, which can reduce strength). However, overcementing is not only expensive but may have deleterious effects such as long term creep, decreased durability, etc. In short, increasing concrete fluidity to the point of being self-leveling or self-consolidating using conventional methods comes at significant cost, be it the cost of expensive admixtures, increased cement, reduced strength, increased segregation and bleeding, reduced durability and/or increased long term creep.

In contrast, the present disclosure enables the manufacture of self-consolidating concrete without significant bleeding or segregation and without the inclusion of high quantities of expensive fluidizing admixtures, rheology-modifying agents, fine particulate fillers, and greatly increased cement content. Using an amount of fine aggregate and coarse aggregate within the narrowly defined ranges minimizes viscosity, which greatly increases spread as defined by ASTM C 1611/C 161 1M, while also increasing cohesion, reducing segregation and bleeding, and eliminating or substantially reducing the need for expensive fluidizing admixtures, rheology-modifying agents, fine particulate fillers, and increased cement content. Self-consolidating concrete manufactured according to the disclosure will typically have less than about 10% by volume of entrained air, preferably less than about 8% by volume of entrained air.

Where gravity alone is relied on to place concrete (i.e., where the shear rate representative of added energy can be treated as if it approaches zero), the yield stress becomes the major component of workability according to the following equation:

$$lim ⇒ \frac{1}{τ} ≅ \frac{1}{{τ}_{o}} \qquad ( 3 )$$

As discussed above, and shown in FIG. 9, concrete slump is inversely related to the yield stress. Thus, if gravity alone were required to place concrete, the slump would be an accurate measure of workability (i.e., increased slump would correlate with increased workability). However, gravity alone is rarely the only force required to place or configure concrete. Instead, concrete must be typically be pumped and/or channeled through a trough, moved into place, consolidated and surface finished.

Where a high amount of placement energy in addition to the force of gravity is required to position concrete (i.e., where the shear rate representative of added energy can be treated as if it approaches infinity), the viscosity of concrete becomes the major component of workability according to the following equation:

$$lim ⇒ \frac{1}{τ} ≅ \frac{1}{{η}_{pl}} \qquad ( 4 )$$

In some cases, both the yield stress and viscosity can significantly contribute to or affect workability according to workability equation (2) shown above.

The vast majority of concrete, whether lower strength concrete used to make sidewalks, driveways and foundations for single dwelling house, or high strength concretes used to manufacture roads, bridges and structural portions of large buildings, has a positive slump in a range of about 1-12 inches (about 2.5-30 cm) as measured using a standard slump cone. Such compositions have substantial Binghamian fluid properties that render slump a poor measure of overall workability. That is because substantial energy above and beyond the force of gravity (i.e., “placement energy”) is generally required to position the concrete into a desired configuration and, in some cases, finish the surface. Slump only measures the flow of concrete under the force of gravity but does not measure the further energy required to position concrete beyond what occurs through gravity alone.

Decreasing the viscosity of fresh concrete generally decreases the overall amount of placement energy or work required to position the concrete into a desired configuration. Conversely, increasing the viscosity generally increases the overall amount of placement energy required to position the concrete into the desired configuration. Because workability is inversely proportional to the amount of placement energy required to position concrete, decreasing the viscosity increases workability because it decreases the amount of placement energy required to position concrete. Because slump only measures the tendency of concrete to flow under the force of gravity, but not the tendency of concrete to flow in response to placement energy input in addition to gravity, in some cases slump is an inaccurate measure of placement workability for concrete that is not 100% self-leveling.

C. Effect of Fine to Course Aggregate Ratio on Rheology

FIG. 3 illustrates a simplified ternary diagram that can be used to graphically depict the relative volumes of cement, rock and sand in a concrete mixture for any point within the triangle. Points within the triangle describe concrete mixtures that include cement, sand and rock. The top point of the triangle near the word “cement” represents a hypothetical composition that includes 100% cement and no sand or rock aggregate. The bottom left point of the triangle near the word “sand” represents a hypothetical composition that includes 100% sand and no cement or rock. The bottom right point of the triangle near the word “rock” represents a hypothetical composition that includes 100% rock and no cement or sand. Any point along the bottom line of the triangle between “sand” and “rock” represents a hypothetical composition that includes various volumetric ratios of sand to rock but no cement. Any line above and parallel to the bottom of the triangle represents compositions having different volumetric ratios of sand and rock but a constant volume of cement.

The hypothetical concrete composition marked by an “X” and labeled as composition 1 includes approximately 15% by volume cement and 85% by volume aggregate. The ratio of rock to sand is approximately 70:30. That is, of the aggregate fraction, 70% of the aggregate is rock and 30% is sand. Composition I represents a typical concrete composition manufactured according to conventional techniques.

The hypothetical concrete composition marked by an “X’ and labeled as composition 2 is derived by shifting horizontally to the left from composition 1 along a line that is parallel to the bottom of the triangle. Therefore, composition 2 also includes approximately 15% by volume cement and 85% by volume aggregate. However, the ratio of rock to sand in composition 2 is approximately 50:50. That is, of the aggregate fraction, 50% of the aggregate is rock and 50% is sand. Composition 2 represents a concrete composition having better workability compared to composition 1.

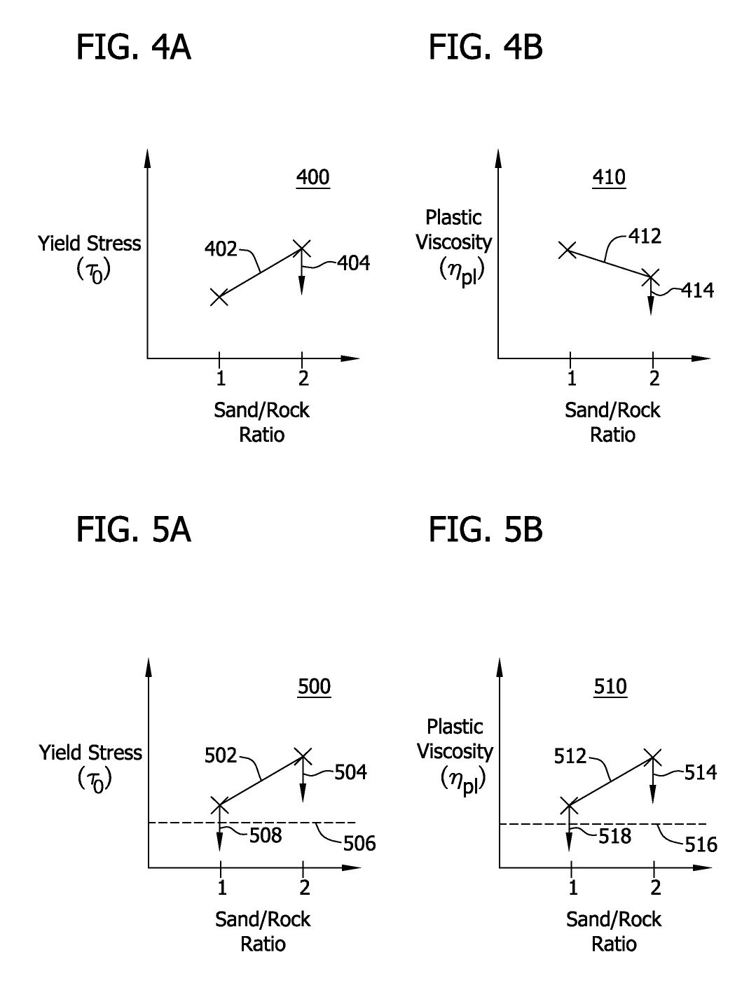

To help explain why composition 2 has better workability compared to composition 1, reference is now made to FIGS. 4A and 4B, which illustrate the effect of increasing the sand to rock ratio on macro rheology (i.e., of the fresh concrete composition), and FIGS. 5A and 5B, which illustrate the effect of increasing the sand to rock ratio on micro rheology (i.e., of the mortar fraction exclusive of the rock fraction).

FIG. 4A is a graph 400 which schematically depicts the effect on the yield stress of the fresh concrete composition by increasing the sand to rock ratio from point 1 to point 2 in the ternary diagram of FIG. 3. Line 402 has a positive slope, which indicates that the yield stress increased by holding the cement volume constant at 15% and increasing the sand to aggregate ratio from 30:70 to 50:50. Increased yield stress correlates to decreased slump.

FIG. 4B is a graph 410 which schematically depicts the effect on the viscosity of a fresh concrete composition by increasing the sand to rock ratio from point 1 to point 2 in the ternary diagram of FIG. 3. Line 412 has a negative slope, which indicates that the plastic viscosity of the composition decreased by holding the cement volume constant at 15% and increasing the sand to aggregate ratio from 30:70 to 50:50. Because decreased viscosity results in increased workability, simply moving from point 1 to point 2 in the ternary diagram of FIG. 3 would have the effect of improving workability notwithstanding the decrease in slump.

Nevertheless, there are situations which require a certain minimum slump for placement. In order to increase the slump (e.g., back to where it was in composition 1), a plasticizer (e.g., water reducer or superplasticizer) can be added, which reduces the yield stress and increases the slump. The effect of adding a plasticizer on yield stress is schematically illustrated in FIG. 4A as line 404 of graph 400. Adding the plasticizer can also beneficially reduce the viscosity, as schematically illustrated by line 414 of graph 410 in FIG. 4B. Thus, the combined effect of increasing the sand to rock ratio and adding a plasticizer can be to maintain a desired slump while substantially decreasing the viscosity. The net effect is a substantial decrease in the placement energy required to configure the concrete, which equates to a substantial increase in workability.

This increase in workability can also be achieved without a corresponding increase in segregation and/or bleeding, which would occur if one were to attempt to lower the viscosity of composition 1 using a plasticizer. This is best understood by comparing the effects of the sand to rock ratio as between compositions 1 and 2 on the micro rheology of fresh concrete, as illustrated in FIGS. 5A and 5B. FIG. 5A is a graph 500 which schematically depicts the effect on the yield stress of the mortar fraction by increasing the sand to rock ratio from point 1 to point 2 in the ternary diagram of FIG. 3. Line 502 has a positive slope, which indicates that the yield stress of the mortar fraction increased by holding the cement volume constant at 15% and increasing the sand to aggregate ratio from 30:70 to 50:50.

FIG. 5B is a graph 510 which schematically depicts the effect on the viscosity of the mortar fraction by increasing the sand to rock ratio from point 1 to point 2 in the ternary diagram of FIG. 3. Line 512 also has a positive slope, which indicates that the plastic viscosity of the mortar fraction increased by holding the cement volume constant at 15% and increasing the sand to aggregate ratio from 30:70 to 50:50. The increase in viscosity and yield stress of the mortar fraction by moving from point 1 to point 2 in the ternary diagram of FIG. 3 improves workability of the fresh concrete because it translates into increased cohesiveness, which decreases segregation and bleeding. The increase in cohesiveness can be beneficial in and of itself, as it can be achieved while also decreasing the macro viscosity of the fresh concrete composition.

The increased cohesiveness also provides a margin of safety that permits greater use of plasticizers to improve concrete workability. Referring again to graph 500 of FIG. 5A, dotted line 506 schematically depicts a minimum yield stress threshold of the mortar fraction below which an unacceptable level of segregation and/or bleeding of the fresh concrete composition occurs. Simply adding a plasticizer to composition 1, as schematically illustrated by line 508 of graph 500, can cause the yield stress of the mortar fraction to dip below the minimum yield stress threshold 506 required to prevent unacceptable segregation and/or bleeding. Dotted line 516 of graph 510 in FIG. 5B depicts a similar minimum viscosity threshold required to prevent unacceptable segregation and/or bleeding. Simply adding a plasticizer to composition 1, as schematically illustrated by line 518 of graph 510, can cause the viscosity of the mortar fraction to dip below the minimum viscosity threshold required to prevent unacceptable segregation and/or bleeding.

In contrast, the increased yield stress and viscosity of the mortar fraction in composition 2, as depicted in FIGS. 5A and 5B, provides a margin of safety that permits greater use of plasticizers to improve concrete workability of the fresh concrete composition while minimizing or eliminating segregation and bleeding. This margin of safety is schematically illustrated by line 504 of graph 500 in FIG. 5A and line 514 of graph 510 of FIG. 5B, which show how the yield stress and viscosity of the mortar fraction of composition 2 can be decreased using a plasticizer while remaining above the minimum yield stress and viscosity thresholds 506 and 516 required to prevent unacceptable segregation and/or bleeding.

In summary, FIGS. 3-5 schematically illustrate the beneficial effect of increasing the sand to rock ratio on workability, and also the ability to employ greater use of plasticizers to further improve workability beyond what is possible using conventional concrete compositions and design techniques. While increasing the ratio of sand to rock is generally beneficial from the standpoint of workability, it has been found that the optimal amount of fine aggregate can vary depending on concrete strength, which is a function of the cement content. That is because both cement and the fine aggregate affect the macro and micro rheology of concrete. In general, increasing the cement content generally reduces the amount of fine aggregate required to optimize workability of a fresh concrete composition. Conversely, decreasing the cement content increases the amount of fine aggregate required to optimize workability of a fresh concrete composition. The optimal ratio of fine to coarse aggregate will therefore roughly depend on concrete strength.

D. Relationship Between Concrete Strength, Workability and Optimal Aggregate Ratios

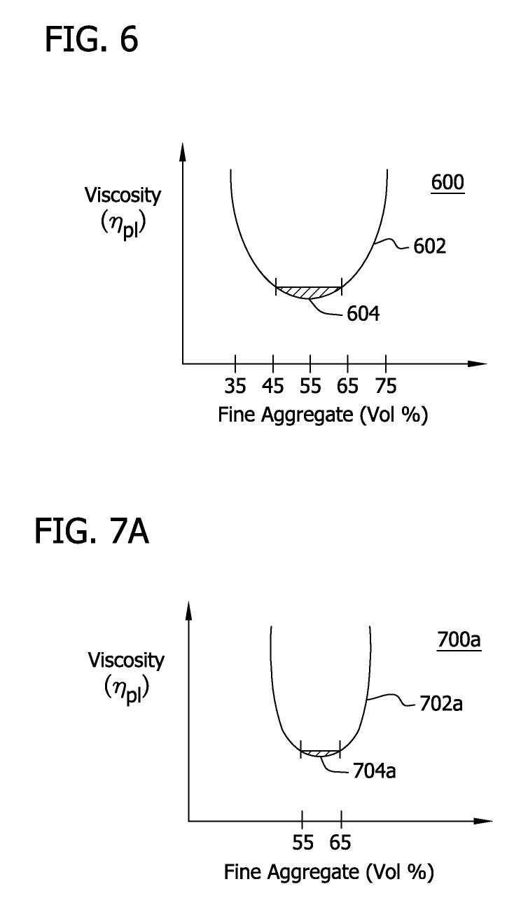

The workability of concrete can be improved by lowering concrete viscosity as a result of carefully controlling the fine-to-coarse aggregate ratio. FIG. 6 depicts a graph 600 which includes a schematic viscosity curve 602 relating the viscosity of a fresh cementitious composition having a slump in a range of about 1-12 inches (about 2.5-30 cm) and a 28-day compressive strength of at least about 1500 psi (about 10 MPa) to the volume percent of fine aggregate. Viscosity curve 602 approximates the viscosity of fresh concrete as the volume of the fine aggregate fraction varies between about 35-75% of the of the total aggregate volume (corresponding to the coarse aggregate fraction varying between about 65-25% of the of the total aggregate volume).

As shown in FIG. 6, viscosity curve 602 has a minimum 604 where the volume of the fine aggregate fraction is between about 45-65% of the total aggregate volume (i.e., with a corresponding coarse aggregate volume of about 35-55% of the total aggregate). Increasing the volume of the fine aggregate fraction from about 30% to between about 45-65% (i.e., decreasing the coarse aggregate fraction from about 70% to about 35-55%) dramatically lowers the viscosity, while minimizing segregation and bleeding, which greatly improve workability, all things being equal. Increasing the volume of fine aggregate above about 65% or below about 45% (i.e., decreasing the coarse aggregate volume to below about 35% or above about 55%) dramatically increases the viscosity, which adversely affects workability. Maintaining a volume of fine aggregate between about 45-65% and a coarse aggregate volume between about 35-55% of the total aggregate volume provides a “sweet spot” where viscosity, segregation and bleeding are minimized to provide maximum workability.

Preferably, the volume of fine aggregate is in a range of 47% to 63%, and the coarse aggregate volume is in a range of 37% to 53%, of the total aggregate volume. More preferably, the volume of fine aggregate is in a range of 48.5% to 61.5%, and the volume of coarse aggregate is in a range of 38.5% to 51.5%, of the total aggregate volume. Most preferably, the volume of fine aggregate is greater than 50% and less than 60%, and the volume of coarse aggregate ranges is greater than 40% and less than 50%, of the total aggregate volume. The foregoing ranges and other similar ranges measure the material aggregate volume (i.e., the bulk volume minus the void fraction).

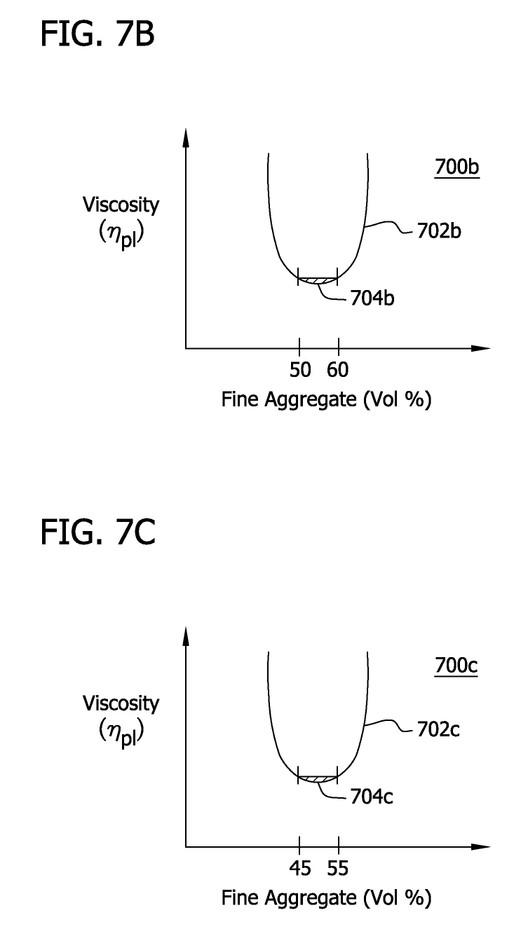

In general, the amount of fine aggregate required to maximize workability while minimizing segregation and bleeding decreases with increasing concrete strength. FIG. 7A depicts a graph 700a which includes a schematic viscosity curve 702a relating the viscosity of a fresh cementitious composition having a slump in a range of about 1-12 inches (about 2.5-30 cm) and a relatively low 28-day compressive strength (i.e., 1500 to 4500 psi, or 10 to 31 MPa) to the volume percent of fine aggregate. In this embodiment, the viscosity minimum 704a, where workability is maximized, while also minimizing segregation and bleeding, occurs at a volume of fine aggregate of about 55-65% and a coarse aggregate volume of about 35-45% of the total aggregate volume. Preferably, the volume of fine aggregate is in a range of 56.0% to 64.5%, and the volume of coarse aggregate is in a range of 35.5% to 44.0%, of the total aggregate volume. More preferably, the volume of fine aggregate is in a range of 57.0% to 64.0%, and the volume of coarse aggregate is in a range of 36.0% to 43.0%, of the total aggregate volume. Most preferably, the volume of fine aggregate is in a range of 58.0% to 63.5%, and the volume of coarse aggregate is in a range of 36.5% to 42.0%, of the total aggregate volume.

FIG. 7B depicts a graph 400b which includes a schematic viscosity curve 702b relating the viscosity of a fresh cementitious composition having a slump in a range of about 1-12 inches (about 2.5-30 cm) and a moderate 28-day compressive strength (i.e., 4500 to 8000 psi, or 31 to 55 MPa) to the volume percent of fine aggregate. In this embodiment, the viscosity minimum 704b, where workability is maximized, while also minimizing segregation and bleeding, occurs at a volume of fine aggregate of about 50-60% and a coarse aggregate volume of about 40-50% of the total aggregate volume. Preferably, the volume of fine aggregate is in a range of 50.5% to 59.5%, and the volume of coarse aggregate is in a range of 40.5% to 49.5%, of the total aggregate volume. More preferably, the volume of fine aggregate is in a range of 51.0% to 59.0%, and the volume of coarse aggregate is in a range of 41.0% to 49.0%, of the total aggregate volume. Most preferably, the volume of fine aggregate is in a range of 51.5% to 58.5%, and the volume of coarse aggregate is in a range of 41.5% to 48.5%, of the total aggregate volume.

FIG. 7C depicts a graph 700c which includes a schematic viscosity curve 702c relating the viscosity of a fresh cementitious composition having a slump in a range of about 1-12 inches (about 2.5-30 cm) and a high 28-day compressive strength (i.e., at least 8000 psi, or 55 MPa) to the volume percent of fine aggregate. In this embodiment, the viscosity minimum 704c, where workability is maximized, while also minimizing segregation and bleeding, occurs at a volume of fine aggregate of about 45-55% and a coarse aggregate volume of about 45-55% of the total aggregate volume. Preferably, the volume of fine aggregate is in a range of 45.5% to 54.0%, and the volume of coarse aggregate is in a range of 46.0% to 54.5%, of the total aggregate volume. More preferably, the volume of fine aggregate is in a range of 46.0% to 53.0%, and the volume of coarse aggregate is in a range of 47.0% to 54.0% of the total aggregate volume. Most preferably, the volume of fine aggregate is in a range of 46.5% to 52.0%, and the volume of coarse aggregate is in a range of 48.0% to 53.5%, of the total aggregate volume.

The foregoing ranges provide for improved workability with minimal segregation and bleeding by minimizing the viscosity by controlling the fine-to-coarse aggregate ratio. Adjusting the ratio of fine-to-coarse aggregate in and around the foregoing ranges has a much greater effect on reducing viscosity, segregation and bleeding than on yield stress. To some degree, the ratio of fine to coarse aggregates affects the viscosity and workability of concrete independently from the cement paste. One reason for this independent effect is that the aggregates have a natural angle of repose. The natural angle of repose relates to the way in which the aggregate, by itself, will flow. This natural angle of repose can be observed when making a pile of aggregate. Aggregates that flow better will make a flatter pile, while aggregates that flow more poorly will make a steeper pile. This natural angle of repose is independent of the rheology of the cement paste, and may account for the particle-particle interactions that increase viscosity when the quantity of coarse aggregate predominates over that of the fine aggregates.

E. Relationship Between Yield Stress, Workability, Segregation and Bleeding

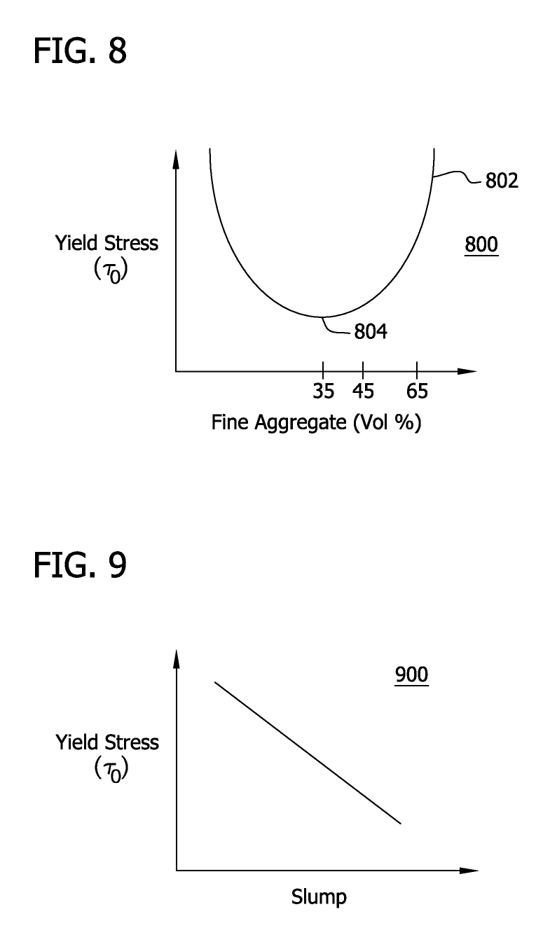

The ratio of fine-to-coarse aggregates can also affect the yield stress. FIG. 8 depicts a graph 800 which includes a schematic yield stress curve 802 relating the yield stress of a fresh cementitious composition having a slump in a range of about 1-12 inches (about 2.5-30 cm) and a 28-day compressive strength of at least about 1500 psi (or 10 MPa) to the volume percent of fine aggregate. As shown in FIG. 8, the yield stress minimum 804 in this example occurs at a fine aggregate volume of about 30% as a fraction of the overall aggregate volume. This is outside and considerably lower than the fine aggregate volume where viscosity reaches a minimum (i.e., between 45-65%), with minimal segregation and bleeding. At a fine aggregate volume of between 45-65% of the overall aggregate volume, the yield stress is significantly, but not overwhelmingly, greater than at a fine aggregate volume of 30%. Minimizing viscosity, segregation and bleeding, while only moderately increasing the yield stress, results in greater concrete workability as it relates to positioning and finishing concrete. As discussed above, minimizing viscosity, segregation and bleeding substantially improves placement workability. Increasing yield stress can, in some cases, improve finishing workability.

FIG. 9 depicts a graph that schematically illustrates the inverse relationship between yield stress and concrete slump. An increase in slump correlates to a decrease in yield stress, which according to those in the industry, translates into increased workability. In direct contrast, optimizing workability according to the disclosure might actually result in concrete having decreased slump relative to conventional concrete compositions. That is surprising and unexpected in view of the conventional reliance on slump as the measure of workability.

A moderate increase in yield stress (i.e., a decrease in slump) can be beneficial to overall workability. In some cases, higher slump concrete can negatively impact overall concrete workability. For example, increasing the slump generally increases the time required for the concrete to become sufficiently firm so that it can be finished. In addition, slump measurements themselves can be misleading as concrete that is prone to segregation might give a false slump reading (i.e., one that does not accurately measure true concrete flow under the force of gravity). Selecting a fine aggregate content between 45-65% avoids the foregoing problems by reducing slump and/or increasing the accuracy of slump measurements by minimizing segregation and bleeding.

In one embodiment, the slump is selected to be within a range. Workability can be optimized by providing a concrete composition that has (i) minimum viscosity, (ii) minimal segregation and bleeding, and (iii) a desired slump within the range. In one embodiment, the slump is preferably in a range from about 2 inches to about 10 inches (or about 5-25 cm), more preferably in a range from about 2 inches to about 8 inches (or about 5-20 cm), and most preferably in a range from about 2 inches to about 6 inches (or about 5-15 cm), as measured using ASTM-C143. The present disclosure is particularly advantageous for achieving good overall workability in these slump ranges by minimizing viscosity and reducing the wait time for finishing the concrete. In addition, the improved workability at the desired slump can be achieved with either none or a lower quantity of admixtures typically needed to improve workability and/or hold high flowing concrete together (e.g., admixtures used to make self-consolidating concrete).

The present disclosure can be particularly advantageous for concrete designed for use in flatwork such as driveways, sidewalks, patios, porches, garage floors, concrete floors, and the like. Those skilled in the art are familiar with concrete mix designs that are suitable for use as flatwork and that can be optimized by minimizing the viscosity as a function of fine aggregate content.

### IV. Methods for Making Cementitous Compositions

The cementitious compositions of the disclosure can be manufactured using any mix design that is compatible with the use of fine aggregates and coarse aggregates with the fine aggregate content between about 45-65% by volume of the total aggregate. For example, in general, currently existing mix designs that have fine aggregate contents of between 30-40% by volume of the total aggregate can be improved according to the present disclosure by adjusting the fine aggregate content to between 45-65% and the coarse aggregate content to between 35-55% of the total aggregate by volume.

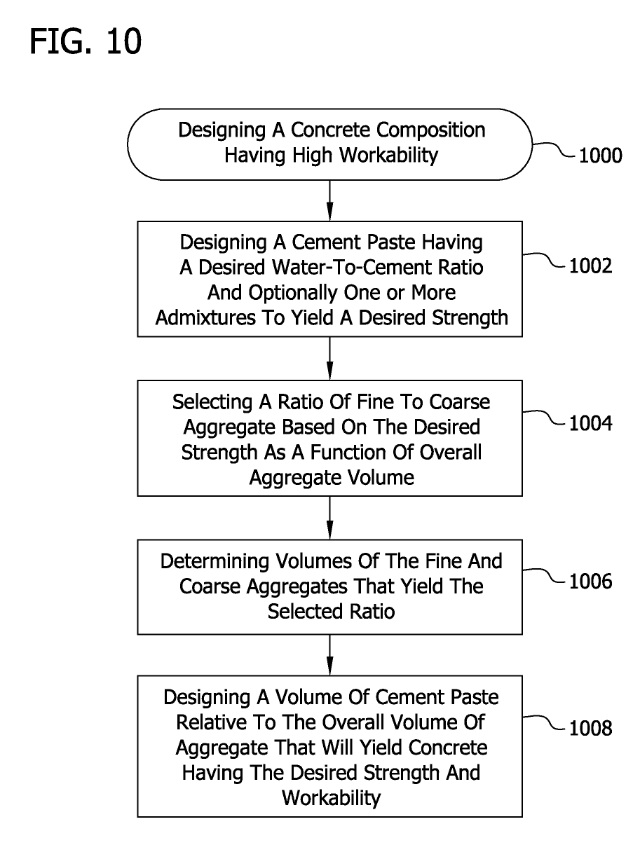

The present disclosure includes methods for designing a concrete composition having high workability. FIG. 10 is a flow diagram 1000 describing the steps that can be used to design concrete having high workability. Step 1002 includes designing a cement paste having a desired water-to-cement ratio to yield a desired strength. The cement paste can optionally include any number or any amount of admixtures that will contribute to yielding paste having the desired strength. Optionally, the cement paste can also include admixtures to adjust the rheology or other properties of the cement paste.

In step 1004, the ratio of fine aggregates to coarse aggregates is selected in part based on the desired strength. The ratio of fine aggregates to coarse aggregates is selected so as to minimize the viscosity of the concrete composition, with minimal segregation and bleeding.

In one embodiment, the fine-to-coarse aggregate ratio is selected by first determining whether the desired strength (e.g., 28-day compressive strength) is relatively low strength (i.e., in a range from about 1500 psi to about 4500 psi), medium strength (i.e., in a range from about 4500 psi to about 8000 psi), or high strength (i.e., in a range from about 8000 psi to about 16000 psi). For relatively low strength concrete, the aggregate is selected to include about 55-65% by volume fine aggregate and about 35-45% by volume coarse aggregate. For medium strength concrete, the aggregate is selected to include between 50-60% by volume aggregate and between 40-50% by volume coarse aggregates. For high strength concrete, the aggregate is selected to include about 45-55% by volume fine aggregate and about 45-55% by volume coarse aggregate.

Step 1006 includes determining the volume of fine aggregate and also the volume of coarse aggregate that will yield the ratio of fine to coarse aggregates selected in step 1004. Similarly, step 1008 includes determining the volume of a desired cement paste relative to the overall volume of fine and coarse aggregates that will yield a concrete composition having the desired strength and workability.

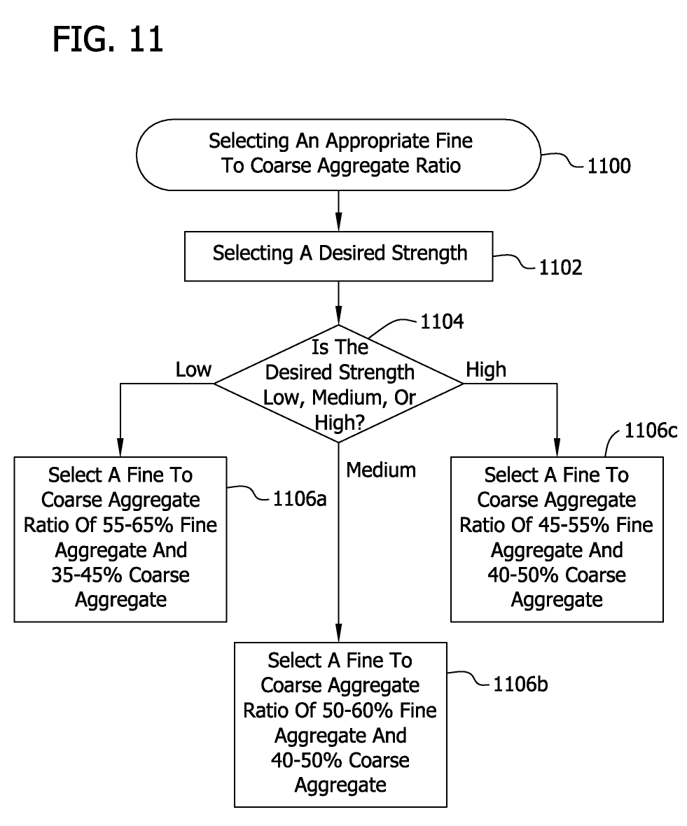

FIG. 11 provides a flow chart 1100 describing one method for selecting an appropriate fine to coarse aggregate ratio. In step 1102, the desired strength is selected and, in step 1104, a decision is made as to whether the desired strength is low (e.g., between 1500-4500 psi), medium (e.g., between 4500-8000 psi), or high (e.g., above 8000 psi). The selection of an appropriate fine-to-coarse aggregate ratio for low, medium and high strength concretes is shown in alternative steps 1106a, 1106b, or 1106c, respectively.

In an alternative embodiment, the desired ratio of fine to coarse aggregates can be determined by constructing a narrow range of the fine aggregate content that minimizes viscosity, segregation and bleeding of the concrete composition. In one embodiment, a fine to coarse aggregate ratio is selected to give a viscosity that is within about 5% of the viscosity minimum, more preferably within about 4% of the viscosity minimum, and most preferably within about 3% of the viscosity minimum, while minimizing or eliminating segregation and bleeding.

With reference again to FIG. 10, in step 1006, the volumes of the fine and coarse aggregates that yield the selected ratio is determined. This determination is typically made by calculating the total amount of concrete that is to be manufactured and calculating the volume of each of the coarse and fine aggregates needed for that volume. The volume of the aggregates to be used in the mix design can also be converted to a weight value (e.g., pounds or kilograms) to facilitate measuring and dispensing the aggregates during the actual mixing process. In step 1008, the quantity of cement paste relative to the quantity of total aggregate is determined such that the concrete manufactured from these two components will yield concrete having the desired strength and workability.

The cementitious compositions can be manufactured using any type of mixing equipment so long as the mixing equipment is capable of mixing together a cementitious composition with the desired ratios of fine aggregates to coarse aggregates to achieve the improvement in workability. Those skilled in the art are familiar equipment that is suitable for manufacturing cementitious composition having both fine and coarse aggregates.

In one embodiment, the cementitious composition of the disclosure is manufactured in a batch plant. Batch plants can be advantageously used to prepare cementitious compositions according to the present disclosure. Batching plants typically have large scale mixers and scales for dispensing the components of the concrete in desired amounts. The use of equipment that can accurately measure and/or dispense the components of the concrete composition advantageously allows the workability to be controlled to a greater extent than using a look and feel approach. Thus, obtaining the desired ratio of aggregates within the narrow ranges that give the most improvement in workability can be more easily achieved in a batching plant. In one embodiment, the batching plant is computer controlled to precisely measure and dispense the components to be mixed. For purposes of this disclosure, batching plants are concrete manufacturing plants with the capacity to mix at least about 1 cubic yard (or approximately 1 cubic meter).

V. Examples of Concrete having Improved Workability

The following mix designs are given solely by way of example in order to illustrate concrete compositions which may be manufactured according to the disclosure so as to minimize viscosity as a function of the aggregate content. Examples that are provided in the past tense were actually manufactured and those in the present tense are either hypothetical in nature or else extrapolations from actual mix designs that were manufactured and tested.

### EXAMPLES 1-5

Various cementitious composition were manufactured by preparing a cement paste having a water-to-cement ratio of 1.0 and adding a quantity of aggregates thereto in order to maintain a cement content of 10% by volume of total solids, with the aggregate fraction constituting the remaining 90% of total solids volume. The fine aggregate consisted of sand having a particle size of 0-4 mm, and the coarse aggregate consisted of rock having a particle size of 8-16 mm. The relative amounts of fine and coarse aggregates were varied in order to determine the effect of the fine-to-coarse aggregate ratio on plastic viscosity. The results are shown in Table 1 below:

TABLE 1

| | | | | | Yield |
|---|---|---|---|---|---|
| Example | Fine Agg | Coarse Agg | Fine:Coarse | Viscosity | Stress |
| 1 | 22.22% | 77.78% | 0.2857:1 | 8.5 | 0.22 |
| 2 | 33.33% | 66.67% | 0.50:1 | 8.0 | 0.12 |
| 3 | 44.44% | 55.56% | 0.80:1 | 6.2 | 0.12 |
| 4 | 55.56% | 44.44% | 1.25:1 | 3.7 | 0.19 |
| 5 | 66.67% | 33.33% | 2.0:1 | 6.3 | 0.25 |

The percentages and ratios are measured in terms of volume. The plastic viscosity in Table 1 is expressed in terms of amp.-min., and the yield stress is expressed in terms of amps. The plastic viscosity and yield stress of the various cementitious compositions were determined using a Janke & Kunkel laboratory mixer having a variable speed of 10-1600 RPM/mm. A more detailed description of how this mixer can be used to determine concrete rheology of various mix designs is described in the Andersen Thesis, pp. 48-53. A detailed description of Theological properties determined using the Janke & Kunkel laboratory mixer is described in the Andersen Thesis, pp. 145-165.

As shown in Table 1, the composition which had the lowest viscosity included 55.56% fine aggregate and 44.44% coarse aggregate by volume of the total aggregate (fine and coarse aggregate). Compositions in which the yield stress was at a minimum, which corresponds to those with maximum slump (the conventional measure of workability), had greater volumes of coarse aggregate than sand. Thus, according to the conventional understanding of workability, Examples 2 and 3 would be considered to have the best workability. However, Example 4 is considered to have the best workability according to the present disclosure. This composition also has minimal segregation and bleeding.

### EXAMPLES 6-10

Various cementitious composition where manufactured by preparing a cement paste having a water-to-cement ratio of 0.5 and adding a quantity of aggregates thereto in order to maintain a cement content of 20% by volume of total solids, with the aggregate fraction constituting the remaining 80% of total solids volume. The fine aggregate consisted of sand having a particle size of 0-4 mm, and the coarse aggregate consisted of rock having a particle size of 8-16 mm. The relative amounts of fine and coarse aggregates were varied in order to determine the effect of the fine-to-coarse aggregate ratio on plastic viscosity. The results are shown in Table 2 below:

TABLE 2

| | | | | | Yield |
|---|---|---|---|---|---|
| Example | Fine Agg | Coarse Agg | Fine:Coarse | Viscosity | Stress |
| 6 | 25% | 75% | 0.33:1 | 8.0 | 0.15 |
| 7 | 37.5% | 62.5% | 0.6:1 | 7.0 | 0.08 |
| 8 | 50% | 50% | 1:1 | 4.4 | 0.13 |
| 9 | 62.5% | 37.5% | 1.67:1 | 4.0 | 0.15 |
| 10 | 75% | 25% | 3:1 | 8.0 | 0.27 |

The percentages and ratios are measured in terms of volume. The plastic viscosity in Table 2 is expressed in terms of amp.-min., and the yield stress is expressed in terms of amps. The plastic viscosity and yield stress of the various cementitious compositions were determined using a Janke & Kunkel laboratory mixer having a variable speed of 10-1600 RPM/mm.

As shown in Table 2, the compositions of Examples 8 and 9 had the lowest viscosity. The composition of Example 7 had the lowest yield stress, which corresponds to maximum slump (the conventional measure of workability). According to the conventional understanding of workability, Example 7 would be considered to have the best workability. However, Example 8 is considered to have the best workability according to the present disclosure, when both yield stress and viscosity are considered. This composition also has minimal segregation and bleeding.

Although the examples which follow are hypothetical in nature, they are derived or extrapolated from actual mix designs which have been studied, interpreted and extended using the inventive concepts described herein relative to how the fine-to-coarse aggregate ratio affects concrete rheology, more specifically, how it affects plastic viscosity.

### EXAMPLES 11-20

Various cementitious composition are manufactured by preparing a cement paste having a water-to-cement ratio and a relative concentration of cement paste to aggregates to yield concrete having a 28-day compressive strength of 3000 psi. The fine aggregate consists of sand having a particle size of 0-4 mm, and the coarse aggregate consists of rock having a particle size of 8-16 mm. The relative amounts of fine and coarse aggregates are varied across a range in order to reduce and/or minimized plastic viscosity across an expected spectrum. Changes in the ratio of fine-to-coarse aggregate may also affect yield stress to some degree. The hypothetical mix designs and results are set forth in Table 3 below:

TABLE 3

| | | | | | Yield |
|---|---|---|---|---|---|
| Example | Fine Agg | Coarse Agg | Fine:Coarse | Viscosity | Stress |
| 11 | 50.0% | 50.0% | 1.00:1 | 5.2 | 0.15 |
| 12 | 52.5% | 47.5% | 1.11:1 | 4.5 | 0.16 |
| 13 | 55.0% | 45.0% | 1.22:1 | 3.9 | 0.17 |
| 14 | 56.5% | 43.5% | 1.30:1 | 3.7 | 0.18 |
| 15 | 58.0% | 42.0% | 1.38:1 | 3.6 | 0.19 |
| 16 | 59.5% | 40.5% | 1.47:1 | 3.5 | 0.20 |
| 17 | 61.0% | 39.0% | 1.56:1 | 3.6 | 0.21 |
| 18 | 62.5% | 37.5% | 1.67:1 | 3.8 | 0.22 |
| 19 | 65.0% | 35.0% | 1.86:1 | 4.0 | 0.22 |
| 20 | 68.0% | 32.0% | 2.13:1 | 4.9 | 0.24 |

The percentages and ratios are measured in terms of volume. The plastic viscosity in Table 3 is expressed in terms of amp.-min., and the yield stress is expressed in terms of amps. The plastic viscosity and yield stress of the various cementitious compositions are determined using a Janice & Kunkel laboratory mixer having a variable speed of 10-1600 RPM/mm.

As shown in Table 3, the compositions of Examples 13-19 have the lowest viscosity, corresponding to a range of 55.0-65.0% fine aggregate and 35.0-45.0% coarse aggregate by volume of total aggregates. The yield stress increases incrementally with increasing fine aggregate content as a result of reduced particle packing density. According to the conventional understanding of workability, Examples 11 and 12 would be considered to have the best workability. However, Examples 13-19 are considered to have the best workability according to the present disclosure. They also have minimal segregation and bleeding.

Various cementitious composition are manufactured by preparing a cement paste having a water-to-cement ratio and a relative concentration of cement paste to aggregates to yield concrete having a 28-day compressive strength of 6000 psi. The fine aggregate consists of sand having a particle size of 0-4 mm, and the coarse aggregate consists of rock having a particle size of 8-16 mm. The relative amounts of fine and coarse aggregates are varied across a range in order to reduce and/or minimized plastic viscosity across an expected spectrum. Changes in the ratio of fine-to-coarse aggregate may also affect yield stress to some degree. The hypothetical mix designs and results are set forth in Table 4 below:

TABLE 4

| | | | | | Yield |
|---|---|---|---|---|---|
| Example | Fine Agg | Coarse Agg | Fine:Coarse | Viscosity | Stress |
| 21 | 45.0% | 55.0% | 0.82:1 | 4.9 | 0.16 |
| 22 | 47.5% | 52.5% | 0.90:1 | 4.4 | 0.16 |
| 23 | 50.0% | 50.0% | 1.00:1 | 4.0 | 0.17 |
| 24 | 52.0% | 48.0% | 1.08:1 | 3.9 | 0.17 |
| 25 | 54.0% | 46.0% | 1.17:1 | 3.8 | 0.18 |
| 26 | 56.0% | 44.0% | 1.27:1 | 3.8 | 0.19 |
| 27 | 58.0% | 42.0% | 1.38:1 | 3.9 | 0.20 |
| 28 | 60.0% | 40.0% | 1.50:1 | 4.0 | 0.21 |
| 29 | 62.5% | 37.5% | 1.67:1 | 4.4 | 0.22 |
| 30 | 65.0% | 35.0% | 1.86:1 | 4.9 | 0.23 |

The percentages and ratios are measured in terms of volume. The plastic viscosity in Table 3 is expressed in terms of amp.-min., and the yield stress is expressed in terms of amps. The plastic viscosity and yield stress of the various cementitious compositions are determined using a Janke & Kunkel laboratory mixer having a variable speed of 10-1600 RPM/mm.

As shown in Table 4, the compositions of Examples 23-28 have the lowest viscosity, corresponding to a range of 50.0-60.0% fine aggregate and 40.0-50.0% coarse aggregate by volume of total aggregates, with the best results being obtained within a range of 52.0-58.0% fine aggregate. The yield stress increases incrementally with increasing fine aggregate content as a result of reduced particle packing density. According to the conventional understanding of workability, Examples 21 and 22 would be considered to have the best workability. However, Examples 23-28 are considered to have the best workability according to the present disclosure. They also have minimal segregation and bleeding.

### EXAMPLES 31-40

Various cementitious composition are manufactured by preparing a cement paste having a water-to-cement ratio and a relative concentration of cement paste to aggregates to yield concrete having a 28-day compressive strength of 9000 psi. The fine aggregate consists of sand having a particle size of 0-4 mm, and the coarse aggregate consists of rock having a particle size of 8-16 mm. The relative amounts of fine and coarse aggregates are varied across a range in order to reduce and/or minimized plastic viscosity across an expected spectrum. Changes in the ratio of fine-to-coarse aggregate may also affect yield stress to some degree. The hypothetical mix designs and results are set forth in Table 5 below:

TABLE 5

| | | | | | Yield |
|---|---|---|---|---|---|
| Example | Fine Agg | Coarse Agg | Fine:Coarse | Viscosity | Stress |
| 31 | 40.0% | 60.0% | 0.67:1 | 5.1 | 0.12 |
| 32 | 42.5% | 57.5% | 0.74:1 | 4.4 | 0.13 |
| 33 | 45.0% | 55.0% | 0.82:1 | 4.0 | 0.14 |
| 34 | 47.0% | 53.0% | 0.89:1 | 3.8 | 0.14 |
| 35 | 49.0% | 51.0% | 0.96:1 | 3.7 | 0.15 |
| 36 | 51.0% | 49.0% | 1.04:1 | 3.7 | 0.16 |
| 37 | 53.0% | 47.0% | 1.13:1 | 3.8 | 0.17 |
| 38 | 55.0% | 45.0% | 1.22:1 | 4.0 | 0.19 |
| 39 | 57.5% | 42.5% | 1.35:1 | 4.3 | 0.21 |
| 40 | 60.0% | 40.0% | 1.50:1 | 4.9 | 0.24 |

The percentages and ratios are measured in terms of volume. The plastic viscosity in Table 5 is expressed in terms of amp.-min., and the yield stress is expressed in terms of amps. The plastic viscosity and yield stress of the various cementitious compositions are determined using a Janice & Kunkel laboratory mixer having a variable speed of 10-1600 RPM/mm.

As shown in Table 5, the compositions of Examples 33-38 have the lowest viscosity, corresponding to a range of 45.0-55.0% fine aggregate and 45.0-55.0% coarse aggregate by volume of total aggregates. The yield stress increases incrementally with increasing fine aggregate content as a result of reduced particle packing density. According to the conventional understanding of workability, Example 31 would be considered to have the best workability. However, Examples 33-38 are considered to have the best workability according to the present disclosure. They also have minimal segregation and bleeding.

### EXAMPLES 41-44

Concrete compositions having high workability as a result of minimizing viscosity, as well as minimizing segregation and bleeding by increasing cohesiveness, were manufactured according to the mix designs in Table 6 below. The mix designs were developed at least in part by utilizing the design optimization procedure set forth in U.S. application Ser. No. 11/471,293, with emphasis on minimizing viscosity and achieving high cohesiveness to prevent bleeding and segregation rather than simply minimizing materials costs independent of these features. Nevertheless, the compositions were also significantly less expensive than previous concrete compositions manufactured by the same manufacturing plant having the same design strength. The materials cost assumptions are also provided in the table, with the understanding that they will fluctuate over time.

TABLE 6

| | Example | | | | |
|---|---|---|---|---|---|
| | 41 | 42 | 43 | 44 | Cost (US$) |
| Compressive | 3000 | 3000 | 4000 | 4000 | — |
| Strength (psi) | | | | | |
| Slump(inch) | 5 | 5 | 5 | 5 | — |
| Type I Cement | 340 | 299 | 375 | 366 | $101.08/Ton |
| (lbs/yd³) | | | | | |
| Type C Fly Ash | 102 | 90 | 113 | 110 | $51.00/Ton |
| (lbs/yd³) | | | | | |
| Sand (lbs/yd³) | 1757 | 1697 | 1735 | 1654 | $9.10/Ton |
| State Rock | 1452 | 1403 | 1434 | 1367 | $1 1.65/Ton |
| (lbs/yd³) | | | | | |
| Potable Water | 294 | 269 | 294 | 269 | negligible |
| (lbs/yd³) | | | | | |
| Daravair 1400 | 0 | 1.4 | 0 | 1.4 | $3.75/Gal |
| (air entrain.) | | | | | |
| (fi. oz./cwt) | | | | | |
| % Air | 2 | 5.5 | 2 | 5.5 | — |
| Cost ($/yd³) | $36.55 | $33.72 | $38.39 | $37.23 | — |
| Weighted Avg. Cost | $36.76 | | | | |
| ($/yd³) | | | | | |
| Cost Savings ($/yd³) | $3.68 | $5.15 | $8.08 | $6.74 | — |
| Per Mix Design | | | | | |

| | |
|---|---|
| Weighted Avg. | $6.60 |
| Plant Cost | |
| Savings ($/yd³) | |

In addition to reducing the materials cost compared to previous concrete compositions at the manufacturing plant, the four mix designs of Examples 41-44 are able to replace twelve mix designs utilized by the plant previously. Increasing workability and cohesiveness provide greater versatility and permit the plant to reduce the number of mix designs required to satisfy customer need. Reducing the number of mix designs required to satisfy customer need represents an additional cost savings to a manufacturing plant because it simplifies the overall manufacturing process.

### EXAMPLES 45-53

Concrete compositions having high workability as a result of minimizing the viscosity were manufactured according to the mix designs in Table 7 below. The mix designs were developed at least in part by utilizing the design optimization procedure set forth in U.S. application Ser. No. 11/471,293, with emphasis on minimizing viscosity and achieving high cohesiveness to prevent bleeding and segregation rather than simply minimizing materials costs independent of these features. The compositions were also significantly less expensive than previous concrete compositions manufactured by the same manufacturing plant having the same design strength.

TABLE 7

| | Example | | | | | | | | |
|---|---|---|---|---|---|---|---|---|---|
| Component | 45 | 46 | 47 | 48 | 49 | 50 | 51 | 52 | 53 |
| Compressive | 3000 | 3000 | 4000 | 4000 | 5000 | 5000 | 6000 | 6000 | 8500 |
| strength (psi) | | | | | | | | | |
| Slump (inch) | 2-3 | 8 | 2-3 | 8 | 2-3 | 8 | 2-3 | 8 | 5-7 |
| Cement Type | 242 | 242 | 275 | 275 | 308 | 308 | 341 | 341 | 428 |
| 1/11 (lbs/yd³) | | | | | | | | | |
| Slag Cement | 161 | 161 | 183 | 183 | 205 | 205 | 227 | 227 | 286 |
| (lbs/yd³) | | | | | | | | | |
| Sand (lbs/yd³) | 1650 | 1650 | 1616 | 1616 | 1576 | 1576 | 1548 | 1548 | 1473 |
| 3/4 in. rock | 972 | 972 | 950 | 950 | 933 | 933 | 917 | 917 | 872 |
| (lbs/yd³) | | | | | | | | | |
| 3/8 in. rock | 413 | 413 | 403 | 403 | 396 | 396 | 389 | 389 | 370 |
| (lbs/yd³) | | | | | | | | | |
| Water (lbs/yd³) | 290 | 290 | 291 | 291 | 292 | 292 | 293 | 293 | 295 |
| Plasticizer (fl. | 5.0 | 5.0 | 5.0 | 5.0 | 5.0 | 5.0 | 6.0 | 6.0 | 10.0 |
| oz/yd³) | | | | | | | | | |
| Air entrain. (fl. | 0.75 | 0.75 | 0.75 | 0.75 | 0.75 | 0.75 | 0.75 | 1.00 | 1.00 |
| oz./yd³) | | | | | | | | | |
| Super plast. | 0.0 | 20.0 | 0.0 | 20.0 | 0.0 | 25.0 | 0.0 | 30.0 | 30.0 |
| (fl.oz./yd³) | | | | | | | | | |
| % Air | 6 | 6 | 6 | 6 | 6 | 6 | 6 | 6 | 6 |
| Cost ($/yd³) | $43.66 | $45.00 | $45.91 | $47.25 | $48.18 | $49.85 | $50.59 | $52.59 | $59.00 |
| Savings ($/yd³) | $3.69 | $4.69 | $4.97 | $6.18 | $7.04 | $8.21 | $8.16 | $820 | $6.90 |

### EXAMPLES 54-64

Concrete compositions having high workability as a result of minimizing the viscosity were manufactured according to the mix designs in Table 8 below. The mix designs were developed at least in part by utilizing the design optimization procedure set forth in U.S. application Ser. No. 11/471,293, with emphasis on minimizing viscosity and achieving high cohesiveness to prevent bleeding and segregation rather than simply minimizing materials costs independent of these features. The compositions were also significantly less expensive than previous concrete compositions manufactured by the same manufacturing plant having the same design strength.

TABLE 8

| | Example | | | | | | | | | | |
|---|---|---|---|---|---|---|---|---|---|---|---|
| Component | 54 | 55 | 56 | 57 | 58 | 59 | 60 | 61 | 62 | 63 | 64 |
| Compressive | 4000 | 5000 | 5950 | 7000 | 8000 | 10k | 12k | 12k | 14k | 15k | 16k |
| strength (psi) | | | | | | | | | | | |
| Slump(inch) | 5 | 8 | 8 | 8 | 8 | 8 | 8 | 8 | 8 | 8 | 8 |
| Cement Type 1/II | 372 | 430 | 462 | 481 | 521 | 420 | 473 | 723 | 527 | 775 | 578 |
| (lbs/yd³) | | | | | | | | | | | |
| Slag Cement | 0 | 0 | 0 | 0 | 0 | 280 | 316 | 0 | 351 | 0 | 385 |
| (lbs/yd³) | | | | | | | | | | | |
| Silica Fume | 0 | 0 | 0 | 0 | 0 | 0 | 0 | 0 | 0 | 28 | 0 |
| (lbs/yd³) | | | | | | | | | | | |
| Fly Ash Class C | 0 | 0 | 0 | 0 | 0 | 0 | 0 | 217 | 0 | 170 | 0 |
| (lbs/yd³) | | | | | | | | | | | |
| Sand (lbs/yd³) | 1680 | 1615 | 1664 | 1615 | 1578 | 1558 | 1491 | 1461 | 1407 | 1291 | 1315 |
| 3/4 in. rock | 958 | 990 | 967 | 922 | 931 | 913 | 1040 | 1047 | 1105 | 1074 | 1088 |
| (lbs/yd³) | | | | | | | | | | | |
| 3/8 in. rock | 413 | 425 | 415 | 396 | 397 | 392 | 446 | 499 | 408 | 472 | 423 |
| (lbs/yd³) | | | | | | | | | | | |
| Water (lbs/yd³) | 254 | 252 | 258 | 252 | 238 | 257 | 260 | 258 | 260 | 252 | 260 |
| Plasticizer | 9 | 0 | 12 | 15 | 22 | 27 | 36 | 12 | 41 | 12 | 44 |
| (fl. oz/yd³) | | | | | | | | | | | |
| Air entrain. | 0.5 | 0.8 | 1.3 | 2.0 | 1.9 | 0.0 | 0.0 | 0.0 | 0.0 | 0.0 | 0.0 |
| (fl. oz./yd³) | | | | | | | | | | | |
| Superplast. | 20 | 25 | 15 | 15 | 14 | 35 | 50 | 64 | 55 | 64 | 60 |
| (fl. oz./yd³) | | | | | | | | | | | |
| % Air | 6 | 6 | 6 | 6 | 6 | 3 | 3 | 3 | 3 | 3 | 3 |
| Cost ($/yd³) | 51.86 | 55.48 | 57.11 | 57.33 | 59.89 | 64.98 | 72.66 | 78.27 | 77.53 | 84.77 | 81.77 |
| Savings ($/yd³) | 13.43 | 15.98 | 17.73 | 10.41 | 10.35 | 28.26 | 38.62 | 33.01 | 51-73 | 51.73 | 51.73 |

### EXAMPLES 65-75

Concrete compositions having high workability as a result of minimizing the viscosity were manufactured according to the mix designs in Table 9 below. The mix designs were developed at least in part by utilizing a design optimization procedure such as set forth in U.S. application Ser. No. 11/471,293, but with emphasis on minimizing viscosity and achieving high cohesiveness to prevent bleeding and segregation rather than simply minimizing materials costs independent of these features. The compositions were also significantly less expensive than previous concrete compositions manufactured by the same manufacturing plant having the same compressive design strength.

TABLE 9

| | Example | | | | | | | | | | |
|---|---|---|---|---|---|---|---|---|---|---|---|
| Component | 65 | 66 | 67 | 68 | 69 | 70 | 71 | 72 | 73 | 74 | 75 |
| Compressive | 4000 | 5000 | 6200 | 6200 | 6200 | 6200 | 8000 | 8600 | 8600 | 8600 | 8600 |
| strength (psi) | | | | | | | | | | | |
| Slump(inch) | 8 | 8 | 7 | 4 | 8 | 8 | 10 | 10 | 8 | 6 | 7 |
| Cement Type 1/II | 372 | 430 | 462 | 462 | 488 | 319 | 480 | 519 | 519 | 548 | 358 |
| (lbs/yd³) | | | | | | | | | | | |
| Slag Cement | 0 | 0 | 0 | 0 | 0 | 213 | 0 | 0 | 0 | 0 | 239 |
| (lbs/yd³) | | | | | | | | | | | |
| Fly Ash Class F | 0 | 0 | 0 | 0 | 146 | 0 | 0 | 0 | 0 | 164 | 0 |
| (lbs/yd³) | | | | | | | | | | | |
| Fly Ash Class C | 112 | 129 | 139 | 139 | 0 | 0 | 144 | 156 | 156 | 0 | 0 |
| (lbs/yd³) | | | | | | | | | | | |
| Sand (lbs/yd³) | 1680 | 1615 | 1664 | 1664 | 1664 | 1664 | 1615 | 1578 | 1578 | 1578 | 1578 |
| 3/4 in. rock | 958 | 990 | 967 | 967 | 967 | 967 | 922 | 931 | 931 | 931 | 931 |
| (lbs/yd³) | | | | | | | | | | | |
| 3/8 in. rock | 413 | 425 | 415 | 415 | 415 | 415 | 396 | 397 | 397 | 397 | 397 |
| (lbs/yd³) | | | | | | | | | | | |
| Water (lbs/yd³) | 254 | 252 | 258 | 253 | 255 | 258 | 238 | 245 | 237 | 234 | 238 |
| Water reducer | 0 | 0 | 12 | 12 | 12 | 12 | 22 | 22 | 24 | 24 | 22 |
| (fl.oz/yd³) | | | | | | | | | | | |
| Air entrain | 0.5 | 0.8 | 0.0 | 2.0 | 2.0 | 2.0 | 0.0 | 0.0 | 2.0 | 2.0 | 2.0 |
| (fl. oz/yd³) | | | | | | | | | | | |
| Super plast. | 20 | 25 | 20.0 | 4.8 | 15.0 | 15.0 | 30.0 | 30.0 | 30 | 30 | 25 |
| (fl. oz./yd³) | | | | | | | | | | | |
| % Air | 3 | 3 | 3 | 6 | 6 | 6 | 3 | 3 | 6 | 6 | 6 |
| Cost ($/yd³) | 49.56 | 53.44 | 57.59 | 56.11 | 59.20 | 55.34 | 59.16 | 61.42 | 61.54 | 63.87 | 58.92 |
| Savings ($/yd³) | 15.74 | 18.03 | 17.26 | 18.74 | 15.65 | 19.51 | 11.07 | 8.82 | 8.69 | 6.37 | 11.31 |

### EXAMPLES 76-86

Concrete compositions having high workability as a result of minimizing the viscosity were manufactured according to the mix designs in Table 10 below. The mix designs were developed at least in part by utilizing a design optimization procedure such as set forth in U.S. application Ser. No. 11/471,293, but with emphasis on minimizing viscosity and achieving high cohesiveness to prevent bleeding and segregation rather than simply minimizing materials costs independent of these features. The compositions were also significantly less expensive than previous concrete compositions manufactured by the same manufacturing plant having the same compressive design strength.

TABLE 10

| | Example | | | | | | | | | | |
|---|---|---|---|---|---|---|---|---|---|---|---|
| Component | 76 | 77 | 78 | 79 | 80 | 81 | 82 | 83 | 84 | 85 | 86 |
| Compressive | 10k | 12k | 14k | 16k | 16k | 16k | 16k | 16k | 16k | 16k | 16k |
| strength (psi) | | | | | | | | | | | |
| Slump (inch) | 10 | 10 | 10 | 10 | 10 | 10 | 10 | 10 | 10 | 10 | 10 |
| Cement Type 1/II | 609 | 680 | 720 | 775 | 708 | 516 | 457 | 411 | 388 | 366 | 300 |
| (lbs/yd³) | | | | | | | | | | | |
| Slag Cement | 0 | 0 | 0 | 0 | 0 | 344 | 305 | 275 | 259 | 244 | 367 |
| (lbs/yd³) | | | | | | | | | | | |
| Silica Fume | 0 | 25 | 25 | 28 | 28 | 28 | 28 | 25 | 24 | 22 | 24 |
| (lbs/yd³) | | | | | | | | | | | |
| Fly Ash Class C | 183 | 204 | 216 | 170 | 304 | 0 | 196 | 176 | 167 | 157 | 129 |
| (lbs/yd³) | | | | | | | | | | | |
| Sand (lbs/yd³) | 1432 | 1454 | 1314 | 1285 | 1285 | 1285 | 1285 | 1296 | 1331 | 1336 | 1338 |
| 3/4 in. rock | 1002 | 1043 | 1124 | 1070 | 1070 | 1070 | 1070 | 1170 | 1137 | 1167 | 1143 |
| (lbs/yd³) | | | | | | | | | | | |
| 3/8 in. rock | 429 | 497 | 482 | 470 | 470 | 470 | 470 | 475 | 487 | 500 | 490 |
| (lbs/yd³) | | | | | | | | | | | |
| Water (lbs/yd³) | 257 | 258 | 260 | 252 | 252 | 252 | 238 | 227 | 214 | 202 | 214 |
| Water reducer (fl. | 27 | 20 | 30 | 12 | 18 | 12 | 12 | 12 | 12 | 12 | 12 |
| oz./yd³) | | | | | | | | | | | |
| Set Retarder | 0.0 | 0.0 | 0.0 | 0.0 | 32.0 | 30.0 | 40.0 | 36.0 | 36.0 | 32.0 | 35.0 |
| (fl. oz./yd³) | | | | | | | | | | | |
| Super plast. | 45.0 | 64.0 | 60.0 | 64.0 | 64.0 | 60.0 | 58.0 | 43.0 | 43 | 43 | 43 |
| (fl. oz./yd³) | | | | | | | | | | | |
| % Air | 3 | 3 | 3 | 3 | 3 | 3 | 3 | 3 | 3 | 3 | 3 |
| Cost ($/yd³) | 68.64 | 81.48 | 83.61 | 84.67 | 85.60 | 81.91 | 82.34 | 76.18 | 74.40 | 72.42 | 73.69 |
| Savings ($/yd³) | 24.20 | 29.80 | 45.65 | 51.73 | 51.73 | 51.73 | 51.73 | 51.73 | 51.73 | 51.73 | 51.73 |

### COMPARATIVE EXAMPLE 87

A conventional self consolidating concrete composition is manufactured having a sand to rock ratio of 30:70, a slump of 28 cm, and a spread of 50 cm. The composition is characterized by significant segregation and bleeding in the absence of adding substantially quantities of a rheology-modifying agent, fine particulate filler (e.g., limestone having a particle size less than 150 microns), and/or substantial overcementing.

### COMPARATIVE EXAMPLE 88

A self-consolidating concrete composition is manufactured according to the disclosure having a sand to rock ratio of 60:40, a slump of 28 cm, and a spread of 65 cm. The composition is characterized as having no significant segregation or bleeding without adding substantial quantities of a rheology-modifying agent, fine particulate filler (e.g., limestone having a particle size less than 150 microns), and/or additional cement. The composition can fill a mold or form cavity without vibration, thereby greatly reducing the cost of placement while also minimizing materials costs.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. A fresh concrete composition having high workability with relatively reduced segregation or bleeding, comprising:
hydraulic cement;
water;
fine aggregate having a volume in a first range between about 45% to about 65% of total aggregate volume; and
coarse aggregate having a volume in a second range between about 35% to about 55% of the total aggregate volume,
the concrete composition having a slump of at least 1 inch and a 28-day compressive strength after curing of at least 1500 psi,
the concrete composition having lower viscosity and greater cohesiveness compared to a concrete composition having a volume of fine aggregate immediately less than the first range and a volume of coarse aggregate immediately greater than the second range.

2. A fresh concrete composition as in claim 1, wherein the fine aggregate has a volume in a range of about 48.5% to about 61.5% of the total aggregate volume, and wherein the coarse aggregate has a volume in a range of about 38.5% to about 51.5% of the total aggregate volume.

3. A fresh concrete composition as in claim 1, wherein the fine aggregate has a volume between 50% to 60% of the total aggregate volume, and wherein the coarse aggregate has a volume between 40% to 50% of the total aggregate volume.

4. A fresh concrete composition as in claim 1, wherein the 28-day compressive strength after curing is in a range from 1500 psi to 4500 psi, wherein the fine aggregate has a volume in a range of about 55% to about 65% of the total aggregate volume, and wherein the coarse aggregate has a volume in a range of about 35% to about 45% of the total aggregate volume.

5. A fresh concrete composition as in claim 4, wherein the fine aggregate has a volume in a range of about 57.0% to about 64.0% of the total aggregate volume, and wherein the coarse aggregate has a volume in a range of about 36.0% to about 43.0% of the total aggregate volume.

6. A fresh concrete composition as in claim 4, wherein the fine aggregate has a volume in a range of about 58.0% to about 61.5% of the total aggregate volume, and wherein the coarse aggregate has a volume in a range of about 36.5% to about 42.0% of the total aggregate volume.

7. A fresh concrete composition as in claim 1, wherein the 28-day compressive strength after curing is in a range from 4500 psi to 8000 psi, wherein the fine aggregate has a volume in a range between 50% to 60% of the total aggregate volume, and wherein the coarse aggregate has a volume in a range between 40% to 50% of the total aggregate volume.

8. A fresh concrete composition as in claim 7, wherein the fine aggregate has a volume in a range of about 51.0% to about 59.0% of the total aggregate volume, and wherein the coarse aggregate has a volume in a range of about 41.0% to about 49.0% of the total aggregate volume.

9. A fresh concrete composition as in claim 7, wherein the fine aggregate has a volume in a range of about 51.5% to about 58.5% of the total aggregate volume, and wherein the coarse aggregate has a volume in a range of about 41.5% to about 48.5% of the total aggregate volume.

10. A fresh concrete composition as in claim 1, wherein the 28-day compressive strength after curing is greater than 8000 psi, wherein the fine aggregate has a volume in a range of about 45% to about 55% of the total aggregate volume, and wherein the coarse aggregate has a volume in a range of about 45% to about 55% of the total aggregate volume.

11. A fresh concrete composition as in claim 10, wherein the fine aggregate has a volume in a range of about 46.0% to about 53.0% of the total aggregate volume, and wherein the coarse aggregate has a volume in a range of about 47.0% to about 54.0% of the total aggregate volume.

12. A fresh concrete composition as in claim 10, wherein the fine aggregate has a volume in a range of about 46.5% to about 52.0% of the total aggregate volume, and wherein the coarse aggregate has a volume in a range of about 48.0% to about 53.5% of the total aggregate volume.

13. A fresh concrete composition as in claim 1, wherein the slump is in a range of about 2 to about 12, as measured using a 12 inch slump cone according to ASTM C143.

14. A fresh concrete composition as in claim 1, wherein the slump is in a range of about 2 to about 8, as measured using a 12 inch slump cone according to ASTM C143.

15. A fresh concrete composition as in claim 1, wherein the fine aggregate consists essentially of sand, wherein the coarse aggregate consists essentially of rock, and wherein the fresh cementation composition contains less than about 10% entrained air.

16. A fresh concrete composition as in claim 1, further comprising one or more admixtures selected from the group consisting of air entraining agents, strength enhancing amines, dispersants, viscosity modifiers, set accelerators, set retarders, corrosion inhibitors, pigments, wetting agents, water soluble polymers, rheology modifying agents, water repellents, fibers, permeability reducers, pumping aids, fungicidal admixtures, germicidal admixtures, insecticidal admixtures, finely divided mineral admixtures, alkali reactivity reducer, and bonding admixtures.

17. A fresh concrete composition as in claim 1, further comprising an amount of plasticizer that increases slump and decreases viscosity without causing significant segregation or bleeding of the cementitious composition.

18. A fresh concrete composition having high workability with relatively reduced segregation or bleeding, comprising:
hydraulic cement;
water;
fine aggregate having a volume in a first range of about 55% to about 65% of total aggregate volume; and
coarse aggregate having a volume in a second range of about 35% to about 45% of the total aggregate volume,
the concrete composition having a slump in a range of about 1 inch to about 12 inches, as measured using a 12 inch slump cone according to ASTM C143, and a 28-day compressive strength after curing in a range of about 1500 psi to about 4500 psi,
the concrete composition having lower viscosity and greater cohesiveness compared to a concrete composition having a volume of fine aggregate immediately less than the first range and a volume of coarse aggregate immediately greater than the second range.

19. A fresh concrete composition having high workability with relatively reduced segregation or bleeding, comprising:
hydraulic cement;
water;
fine aggregate having a volume greater than 50% and less than 60% of total aggregate volume; and
coarse aggregate having a volume greater than 40% and less than 50% of the total aggregate volume,
the concrete composition having a slump in a range of about 1 inch to about 12 inches, as measured using a 12 inch slump cone according to ASTM C143, and a 28-day compressive strength after curing in a range of about 4500 psi to about 8000 psi,
the concrete composition having a lower viscosity, segregation and bleeding compared to a concrete composition having a volume of fine aggregate immediately less than 50% of total aggregate volume and a volume of coarse aggregate immediately greater than 50% of total aggregate volume.

20. A fresh concrete composition having high workability with relatively reduced segregation or bleeding, comprising:
hydraulic cement;
water;
fine aggregate having a volume in first a range of about 45% to about 55% of total aggregate volume; and
coarse aggregate having a volume in a second range of about 45% to about 55% of the total aggregate volume,
the concrete composition having a slump in a range of about 1 inch to about 12 inches, as measured using a 12 inch slump cone according to ASTM C143, and a 28-day compressive strength after curing of at least about 8000 psi,
the concrete composition having lower viscosity and greater cohesiveness compared to a concrete composition having a volume of fine aggregate immediately less than the first range and a volume of coarse aggregate immediately greater than the second range.

21. A method for designing a concrete composition having high workability with relatively reduced segregation or bleeding, comprising:
designing a cement paste having a desired water-to-cement ratio for achieving a desired strength greater than about 1500 psi after curing;
selecting relative amounts of fine aggregate and coarse aggregate that minimize segregation and bleeding and result in a desired workability; and
determining a volume of cement paste relative to the overall volume of aggregate that will yield concrete having the desired strength, the desired workability, and a slump in a range about 1 inch to about 12 inches, as measured using a 12 inch slump cone according to ASTM C143.

22. A method as in claim 21, wherein the desired strength is in a range of about 1500 psi to about 4500 psi and wherein the fine-to-coarse aggregate ratio yields a volume of fine aggregate in a range of about 55% to about 65% of the total aggregate volume and a volume of coarse aggregate in a range of about 35% to about 45% of the total aggregate volume.

23. A method as in claim 21, wherein the desired strength is in a range of about 4500 psi to about 8000 psi and wherein the fine-to-coarse aggregate ratio yields a volume of fine aggregate in a range of about 50% to about 60% of the total aggregate volume and a volume of coarse aggregate in a range of about 40% to about 50% of the total aggregate volume.

24. A method as in claim 21, wherein the desired strength is greater than about 8000 psi and wherein the fine-to-coarse aggregate ratio yields a volume of fine aggregate in a range of about 45% to about 55% of the total aggregate volume and a volume of coarse aggregate in a range of about 45% to about 55% of the total aggregate volume.

25. A method as in claim 21, further comprising determining a quantity of plasticizer that will increase slump and decrease viscosity without causing significant bleeding or segregation.

26. A method for manufacturing ready-mix concrete having relatively reduced segregation or bleeding, comprising:
providing a batching plant having a batching system capable of dispensing and mixing together desired amounts of cement, water, fine aggregate and coarse aggregate;
forming a fresh concrete composition by mixing together in the batching system a measured quantity of:
hydraulic cement;
water;
fine aggregate in a range of about 45% to about 65% by volume of total aggregate; and
coarse aggregate in a range of about 35% to about 55% by volume of the total aggregate,
the fresh concrete composition having a slump of at least about 1 inch and a 28-day compressive strength after curing of at least about 1500 psi.

27. A method as in claim 26, further comprising adding a plasticizer to the fresh concrete composition in an amount so as to increase slump and decrease viscosity without causing significant segregation or bleeding.
